(19) United States
(12) Patent Application Publication
(10) Pub. No.: US 2014/0185504 A1
(43) Pub. Date: Jul. 3, 2014

(54) COMMUNICATION SYSTEM, COMMUNICATION METHOD, AND CHILD STATION OF COMMUNICATION SYSTEM

(71) Applicants: Naoki Miura, Tokyo (JP); Nobuyuki Tanaka, Tokyo (JP); Takeshi Sakemoto, Tokyo (JP); Masami Urano, Tokyo (JP); Mamoru Nakanishi, Tokyo (JP)

(72) Inventors: Naoki Miura, Tokyo (JP); Nobuyuki Tanaka, Tokyo (JP); Takeshi Sakemoto, Tokyo (JP); Masami Urano, Tokyo (JP); Mamoru Nakanishi, Tokyo (JP)

(73) Assignee: NIPPON TELEGRAPH AND TELEPHONE CORPORATION, Tokyo (JP)

(21) Appl. No.: 14/119,185

(22) PCT Filed: Jun. 22, 2012
(86) PCT No.: PCT/JP2012/066046

§ 371 Date: Nov. 20, 2013

(30) Foreign Application Priority Data
Jun. 24, 2011 (JP) 2011-140291

(51) Int. Cl. H04W 52/02

(52) U.S. Cl. CPC H04W 52/0212
USPC 370/311

(57) ABSTRACT

A child station (3) of a communication system performs communication while synchronizing the reference time of a parent station (2) with the local time (RT) of the child station (3). When the child station (3) is switched from a normal mode to a power saving mode in accordance with a mode change instruction from the parent station (2), correction is performed for one or both of a stop period in which the apparatus of the child station (3) is stopped and a non-stop period in the power saving mode using an error (Δt) generated during the time between the reference time of the parent station (2) and the local time (RT) of the child station (3). This makes it possible to synchronize the parent station (2) with the child station (3) and reliably and efficiently transfer a control frame (CF) from the parent station (2) to the child station (3).

### TECHNICAL FIELD

The present invention relates to a communication system, a communication method, and a child station of the communication system and, for example, to a communication method of, in a communication system formed from a parent station and a child station, shifting the child station from a normal mode to a power saving mode in which some or all of functions have stopped.

### BACKGROUND ART

A PON (Passive Optical Network) system is a conventional communication system formed from a parent station and child stations. The PON system performs communication by point-to-multipoint using an OLT (Optical Line Terminal) installed in a station building as a parent station and an ONU (Optical Network Unit) installed in each user home as a child station.

FIG. 1 shows the arrangement of a PON system 1. Referring to FIG. 1, the PON system 1 includes an OLT 2 installed in a station building, m ONUs 3 (3₋₁, 3₋₂, . . . , 3₋ₘ each installed in a user home, optical fibers 4 that connect the m ONUs 3 (3₋₁, 3₋₂, . . . , 3₋ₘ) to 1: m, and an optical splitter 5. Note that an external network 6 is connected to the OLT 2. The section where the ONUs 3 and the OLT 2 are connected by the optical fibers 4 and the optical splitter 5 will be referred to as a PON section 7.

In the PON system 1, signals transmitted from the plurality of ONUs 3 are bundled by the optical splitter 5 and reach the OLT 2 in this state. Hence, the PON system 1 defines the signal transmission timing of each ONU 3 not to cause confliction between the signals from the ONUs 3 (for example, see non-patent literatures 1 and 2).

The OLT 2 periodically transmits a reference time to each ONU 3 in accordance with the definition and notifies each ONU 3 of time at which it is permitted to transmit a signal. Each ONU 3 sets the local time of its own to the reference time received from the OLT 2, and when the local time has reached the designated time, transmits the signal and communicates with the OLT 2.

In the PON system 1, the ONU 3 is installed in each user home. For this reason, the power consumption of all ONUs 3 makes up a large proportion of the power consumption of the entire network, and the ONUs 3 are required to save power.

The ONU 3 uses, for example, a Cyclic Sleep method as the power saving method (see, for example, non-patent literature 3). In the Cyclic Sleep method, the ONU 3 has two modes, that is, a power saving mode and a normal mode. In the power saving mode, the ONU 3 performs Cyclic Sleep. In the normal mode, Cyclic Sleep is not performed.

In the Cyclic Sleep method, the ONU 3 periodically repeats a Sleep state and an Aware state in the power saving mode. The Sleep state indicates a state in which the apparatus is partially or wholly stopped to suppress power use. The Aware state indicates a state in which the apparatus is activated not to suppress power use. A period during which the ONU 3 is in the Sleep state will be referred to as a Sleep period, and a period during which the ONU 3 is in the Aware state will be referred to as an Aware period hereinafter. The time from the start of the Sleep period to the end of the Aware period will be referred to as one cycle. Signals transmitted/received between the OLT 2 and the ONUs 3 will be referred to as frames for distinction from internal signals of the apparatus. The frames include user frames and control frames. “User frame” is a general term for frames exchanged between the external network 6 and a home network, and “control frame” indicates frames (including a Sleep frame, Sleep_Ack frame, Aware frame, and Aware_Ack frame to be described later) other than the user frames.

FIG. 2 shows the communication process of the Cyclic Sleep method. In the Cyclic Sleep method, the OLT 2 instructs the ONU 3 to shift from the normal mode to the power saving mode or return from the power saving mode to the normal mode.

In actuality, referring to FIG. 2, the OLT 2 first decides, based on traffic and the like, to set a specific ONU 3 in the power saving mode, and transmits a control frame (in this case, Sleep frame) for instructing it to the ONU 3 at time of step ST1. Upon receiving the Sleep frame, the ONU 3 returns a control frame (in this case, Sleep_Ack frame) to the OLT 2 at time of step ST2 to notify it that the ONU 3 has acknowledged the shift to the power saving mode.

After transmitting the Sleep_Ack frame to the OLT 2, the ONU 3 is set in the Sleep state during a preset Sleep period (to be referred to as “T_sleep” hereinafter). When the Sleep period has ended, the ONU 3 is set in the Aware state during a preset Aware period (to be referred to as “T_aware” hereinafter). If no instruction is received from the OLT 2 until the end of the Aware period, the ONU 3 is set in the Sleep state during T_sleep again, and periodically repeats this operation from then on.

In the Cyclic Sleep method, to return the ONU 3 from the power saving mode to the normal mode, the OLT 2 sends a control frame (in this case, Aware frame) for instructing return from the power saving mode to the ONU 3 at time of step ST3. Upon receiving the Aware frame, the ONU 3 returns from the power saving mode to the normal mode, and transmits a control frame (in this case, Aware_Ack frame) to the OLT 2 at time of step ST4 to notify it of the return. From this point, the ONU 3 remains in the normal mode until a control frame (Sleep frame) is received from the OLT 2 again.

Note that in the Cyclic Sleep method, the time at which the Sleep period starts in the first cycle will be referred to as a power saving mode start time, and the OLT 2 and the ONU 3 are synchronized for the power saving mode start time.

FIG. 3 shows detailed examples of the arrangements of the OLT 2 and the ONU 3 that implement the Cyclic Sleep method. The OLT 2 includes a parent station communication unit 21, and (m) parent station power control units 22₋₁ to 22₋ₘ as many as the ONUs connected to the OLT 2.

The OLT 2 implements a protocol defined by non-patent literature 1 or 2 in the parent station communication unit 21. The OLT 2 maintains connection to each ONU 3 while periodically transmitting a control frame from the parent station communication unit 21 to the ONU 3 via the PON section 7 to notify them of the reference time, and transmits a user frame input from the external network 6 to the ONU 3 via the parent station communication unit 21 and the PON section 7. The OLT 2 also transmits a user frame, which is input from a home network 8 to the ONU 3 and transmitted from the ONU 3 via the PON section 7, to the external network 6 via the parent station communication unit 21.

The m parent station power control units 22 (22₋₁ to 22₋ₘ) of the OLT 2 correspond to the ONUs 3 connected to the OLT 2, and control whether the ONUs 3 should be in the power saving mode or the normal mode. In the OLT 2, each parent station power control unit 22 receives traffic Q1 of the corresponding ONU 3 from the parent station communication unit 21. The parent station power control unit 22 decides, based on the traffic Q1, whether to set the ONU 3 in the power saving mode. Each parent station power control unit 22 of the OLT 2 instructs the parent station communication unit 21 to transmit a control frame CF by a control signal C1. The parent station communication unit 21 generates the control frame CF such as the above-described Sleep frame or Aware frame in accordance with the transmission instruction and transmits the control frame CF to the ONU 3.

On the other hand, the ONU 3 includes a child station communication unit 31, a child station power control unit 32, and a child station period measurement unit 33. The ONU 3 implements the same communication protocol as that in the OLT 2 in the child station communication unit 31. The ONU 3 maintains connection to the OLT 2 while establishing time synchronization between the local time of the ONU 3 and the reference time of the OLT 2 based on the reference time transmitted from the OLT 2.

The ONU 3 transmits a user frame UF, which is input from the home network 8, from the child station communication unit 31 to the OLT 2. In addition, the ONU 3 transmits the user frame UF, which is input from the OLT 2 via the PON section 7, from the child station communication unit 31 to the home network 8. When the ONU 3 shifts to the Sleep state or the Aware state, the child station communication unit 31 of the ONU 3 controls stop or activation of the communication function by a stop/activation signal SPST input from the child station power control unit 32.

The child station power control unit 32 of the ONU 3 receives the control frame CF from the OLT 2 via the child station communication unit 31, and manages whether the ONU 3 should be in the power saving mode or the normal mode. More specifically, upon receiving the control frame (Sleep frame) CF from the OLT 2, the child station communication unit 31 of the ONU 3 notifies the child station power control unit 32 of the contents of the control frame (Sleep frame) CF by a control signal C2. As a result, the child station power control unit 32 of the ONU 3 shifts from the normal mode to the power saving mode based on the control signal C2 and repeats the Sleep state and the Aware state in a predetermined period. The child station period measurement unit 33 measures the Sleep period and the Aware period.

In the ONU 3, the child station power control unit 32 outputs a set signal SET and a reset signal RSET to the child station period measurement unit 33, and the child station period measurement unit 33 outputs a Sleep state signal SLM and an Aware state signal AWM to the child station power control unit 32. The set signal SET causes the child station period measurement unit 33 to start measuring the Sleep period and the Aware period. The reset signal RSET causes the child station period measurement unit 33 to stop the measurement. The Sleep state signal SLM is output in the Sleep period. The Aware state signal AWM is output in the Aware period.

In actuality, when the ONU 3 shifts from the normal mode to the power saving mode, the child station power control unit 32 outputs the set signal SET to the child station period measurement unit 33, and the child station period measurement unit 33 starts measuring the Sleep period and the Aware period. The ONU 3 causes the child station power control unit 32 to determine, based on the Sleep state signal SLM and the Aware state signal AWM from the child station period measurement unit 33, whether the ONU 3 is in the Sleep state or the Aware state and output the stop/activation signal SPST to the child station communication unit 31 to instruct stop/activation of the communication function.

In the above-described Cyclic Sleep method, however, the ONU 3 in the Sleep state stops the receiving function of the child station communication unit 31 and cannot receive the control frame (Sleep frame or Aware frame) CF from the OLT 2. For this reason, to return the ONU 3 from the power saving mode to the normal mode, the OLT 2 needs to transmit the control frame (Aware frame) CF of return instruction when the ONU 3 is in the Aware state.

To implement this, the OLT 2 needs to measure the Sleep period and the Aware period and grasp whether the ONU 3 is in the Sleep state or the Aware state. However, because of the clock deviation between the OLT 2 and the ONU 3, an error (Δt) occurs in the measurement of the Sleep period and the Aware period in the Sleep state in which clock synchronization cannot be established. Note that when the clock deviation of the apparatus is 100 ppm, the error (Δt) is about μsec in a 10-msec Sleep period.

Even if small relative to the Sleep period or the Aware period, the error (Δt) accumulates in every cycle and increases to x×Δt in x cycles. For this reason, as shown in FIG. 4, after the cycle has repeated, a case may occur in which the OLT 2 is in the Aware period, whereas the ONU 3 is in the Sleep period. If the OLT 2 transmits the control frame (Aware frame) CF at this timing, the ONU 3 cannot receive it. Hence, the return from the power saving mode to the normal mode is impossible.

To avoid such a situation, the OLT 2 may continuously transmit the control frame (Aware frame) CF of return instruction at an interval much shorter than the Aware period. However, this method not only lowers the band utilization efficiency but also increases the load on the OLT 2 and thus increases the power consumption. Such a measure is necessary because the error (Δt) between the OLT 2 and the ONU 3 is not taken into consideration when measuring the Sleep period and the Aware period.

If the error (Δt) is too large to neglect relative to the Sleep period or the Aware period, the error (Δt) occurs between the OLT 2 and the ONU 3 during the Aware period and the Sleep period in the first cycle, and the same problem as described above arises. This is also because the error (Δt) is not taken into consideration when measuring the Sleep period and the Aware period.

### RELATED ART LITERATURE

### Non-Patent Literature

Non-Patent Literature 1: IEEE Std 802.3-2005: Part 3: Carrier sense multiple access with Collision Detection (CSMA/CD) access method and physicallayer specifications

Non-Patent Literature 2: IEEE Std 802, 3av TM-2009: Part 3: Carrier Sense Multiple Access with Collision Detection (CSMA/CD) access method and physical layer specifications

Non-Patent Literature 3: Ryogo Kubo, Jun-ichi Kani, Yukihiro Fujimoto, Naoto Yoshimoto, and Kiyomi Kumozaki, “Sleep and adaptive link rate control for power saving in 10G-EPON systems”, Proceedings of the IEEE Global Telecommunications Conference, GLOBECOM 2009, pp. 1-6, 2009

### DISCLOSURE OF INVENTION

### Problem to be Solved by the Invention

The present invention has been made in consideration of the problem of the above-described related art, and proposes a communication system capable of improving the band utilization efficiency and reduce the power consumption of the parent station by synchronizing the parent station with the child station in consideration of the error (Δt) when measuring the Sleep period and the Aware period and decreasing the number of times of causing the parent station to transmit the control frame of return instruction, a child station apparatus of the communication system, a communication method, and a program.

### Means of Solution to the Problem

In order to achieve the above-described object, according to the present invention, there is provided a communication system including a parent station and one or a plurality of child stations, the parent station comprising a parent station communication unit that has a reference time and communicates with the plurality of child stations, one or a plurality of parent station power control units each of which determines whether the child station should be in a power saving mode in which an apparatus is periodically partially or wholly stopped or in a normal mode in which the apparatus is operated without being partially or wholly stopped, and instructs the child station to change a mode, and one or a plurality of parent station period measurement units each of which measures a stop period in which the apparatus of the child station is partially or wholly stopped and a non-stop period in which the apparatus of the child station is not stopped in the power saving mode, and the child station comprising a child station communication unit that performs communication while synchronizing the reference time of the parent station with a local time of the child station, a child station power control unit that changes the mode between the power saving mode and the normal mode of the child station in accordance with the mode change instruction from the parent station, and a child station period measurement unit that measures the stop period and the non-stop period of the child station, wherein the child station period measurement unit performs correction for one or both of the stop period and the non-stop period in the power saving mode using an error obtained by calculating a difference that is generated during the power saving mode between the reference time of the parent station and the local time of the child station.

According to the present invention, there is also provided a communication method including a parent station and one or a plurality of child stations that communicate with the parent station, comprising a reference time notification step of causing a parent station communication unit of the parent station, which has a reference time, to communicate with the plurality of child stations, thereby transmitting the reference time of the parent station to the child stations, a time synchronization step of causing a child station communication unit of each of the child stations to receive the reference time of the parent station and synchronize the reference time of the parent station with a local time of the child station, a mode change instruction step of causing one or a plurality of parent station power control units of the parent station to determine whether the child station should be in a power saving mode in which an apparatus is periodically partially or wholly stopped or in a normal mode in which the apparatus is operate without being partially or wholly stopped, and instruct the child station to change a mode, a mode change processing step of causing a child station power control unit of the child station to change the mode between the power saving mode and the normal mode of the child station in accordance with the mode change instruction from the parent station, a parent station period measurement step of causing one or a plurality of parent station period measurement units of the parent station to measure a stop period in which the apparatus of the child station is partially or wholly stopped in the power saving mode and a non-stop period in which the apparatus of the child station is not stopped, and a child station period measurement step of causing a child station period measurement unit of the child station to measure the stop period and the non-stop period of the child station, wherein in child station period measurement step, correction for one or both of the stop period and the non-stop period in the power saving mode is performed using an error obtained by calculating a difference that is generated during the power saving mode between the reference time of the parent station and the local time of the child station.

According to the present invention, there is also provided a communication system including a parent station and one or a plurality of child stations, the parent station comprising a parent station communication unit that has a reference time and communicates with the plurality of child stations, one or a plurality of parent station power control units each of which determines whether the child station should be in a power saving mode in which an apparatus is periodically partially or wholly stopped or in a normal mode in which the apparatus is operated without being partially or wholly stopped, and instructs the child station to change a mode, and one or a plurality of parent station period measurement units each of which measures a stop period in which the apparatus of the child station is partially or wholly stopped and a non-stop period in which the apparatus of the child station is not stopped in the power saving mode, and the child station comprising a child station communication unit that performs communication while synchronizing the reference time of the parent station with a local time of the child station, a child station power control unit that changes the mode between the power saving mode and the normal mode of the child station in accordance with the mode change instruction from the parent station, and a child station period measurement unit that measures the stop period and the non-stop period of the child station, wherein the child station period measurement unit obtains an error by calculating a difference that is generated during the power saving mode between the reference time of the parent station and the local time of the child station, and the child station communication unit transmits the error to the parent station, and the parent station period measurement unit performs the correction for one or both of the stop period and the non-stop period in the power saving mode using the error received from the child station by the parent station communication unit.

According to the present invention, there is also provided a communication method including a parent station and one or a plurality of child stations that communicate with the parent station, comprising a reference time notification step of causing a parent station communication unit of the parent station, which has a reference time, to communicate with the plurality of child stations, thereby transmitting the reference time of the parent station to the child stations, a time synchronization step of causing a child station communication unit of each of the child stations to receive the reference time of the parent station and synchronize the reference time of the parent station with a local time of the child station, a mode change instruction step of causing one or a plurality of parent station power control units of the parent station to determine whether the child station should be in a power saving mode in which an apparatus is periodically partially or wholly stopped or in a normal mode in which the apparatus is operate without being partially or wholly stopped, and instruct the child station to change a mode, a mode change processing step of causing a child station power control unit of the child station to change the mode between the power saving mode and the normal mode of the child station in accordance with the mode change instruction from the parent station, a parent station period measurement step of causing one or a plurality of parent station period measurement units of the parent station to measure a stop period in which the apparatus of the child station is partially or wholly stopped in the power saving mode and a non-stop period in which the apparatus of the child station is not stopped, and a child station period measurement step of causing a child station period measurement unit of the child station to measure the stop period and the non-stop period of the child station, wherein in child station period measurement step, an error is obtained by calculating a difference that is generated during the power saving mode between the reference time of the parent station and the local time of the child station, and the child station communication unit transmits the error to the parent station, and in the parent station period measurement step, the correction for one or both of the stop period and the non-stop period is performed in the power saving mode using the error received from the child station by the parent station communication unit.

According to the present invention, there is also provided a child station of a communication system, comprising a child station communication unit that performs communication while synchronizing a reference time of a parent station of the communication system with a local time of the child station itself, a child station power control unit that changes a mode between a power saving mode in which an apparatus is periodically partially or wholly stopped and a normal mode in which the apparatus is operated without being partially or wholly stopped in accordance with a mode change instruction from the parent station, and a child station period measurement unit that measures the stop period in which the apparatus of the child station is partially or wholly stopped and the non-stop period in which the apparatus of the child station is not stopped in the power saving mode, wherein the child station period measurement unit performs correction for one or both of the stop period and the non-stop period in the power saving mode using an error obtained by calculating a difference that is generated during the power saving mode between the reference time of the parent station and the local time of the child station.

According to the present invention, there is also provided a communication method comprising a communication step of causing a child station communication unit of a child station to perform communication while synchronizing a reference time of a parent station including in a communication system with a local time of the child station including in the communication system and connected to the parent station, a mode change step of causing a child station power control unit of the child station to change a mode of the child station between a power saving mode and a normal mode of the child station in accordance with a mode change instruction from the parent station, and a measurement step of causing a child station period measurement unit of the child station to measure a stop period in which an apparatus of the child station is partially or wholly stopped and the non-stop period in which the apparatus of the child station is not stopped in the power saving mode, wherein in the measurement step, correction for one or both of the stop period and the non-stop period is performed in the power saving mode using an error obtained by calculating a difference that is generated during the power saving mode between the reference time of the parent station and the local time of the child station.

### Effect of the Invention

According to the present invention, using the error that occurs between the reference time of the parent station and the local time of the child station during the power saving mode, correction is performed for one or both of the stop period and the non-stop period in the power saving mode. This makes it possible to synchronize the parent station with the child station and reliably transfer a control frame from the parent station to the child station. It is therefore possible to decrease the number of times of causing the parent station to transmit the control frame of return instruction and also improve the band utilization efficiency and thus reduce the power consumption of the parent station.

### BRIEF DESCRIPTION OF DRAWINGS

FIG. 1 is a block diagram showing the overall arrangement of a PON system;

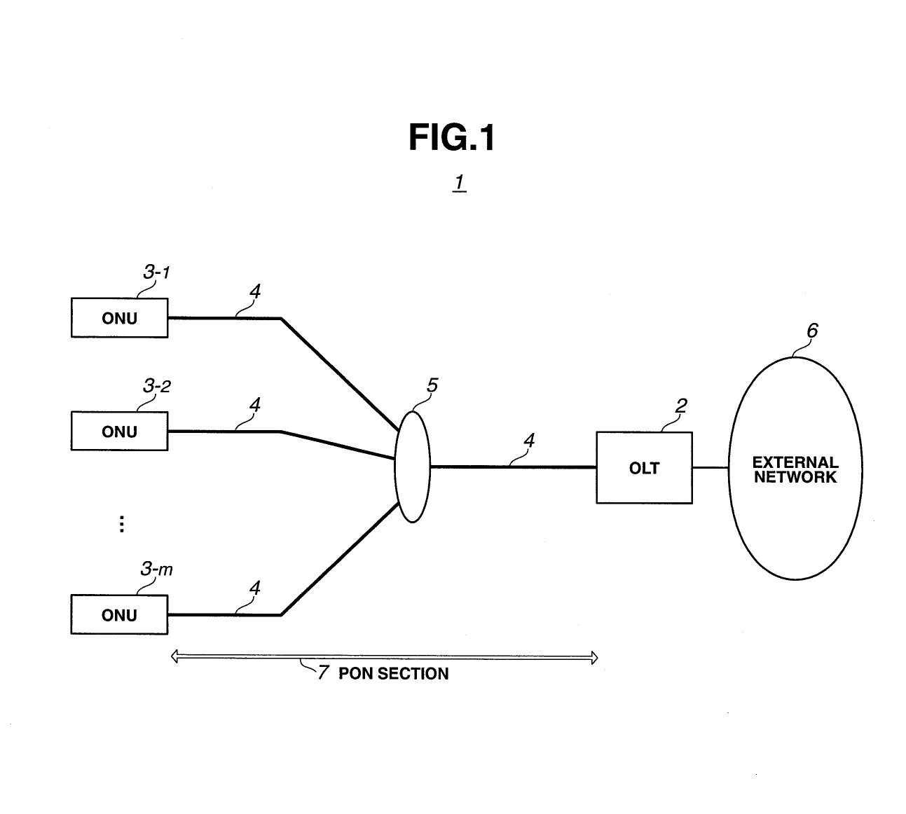

FIG. 2 is a view for explaining the communication process of a conventional PON system;

FIG. 3 is a block diagram showing the circuit arrangements of an OLT and an ONU;

FIG. 4 is a view for explaining a case in which a return from a power saving mode to a normal mode is impossible in the communication process of the conventional PON system;

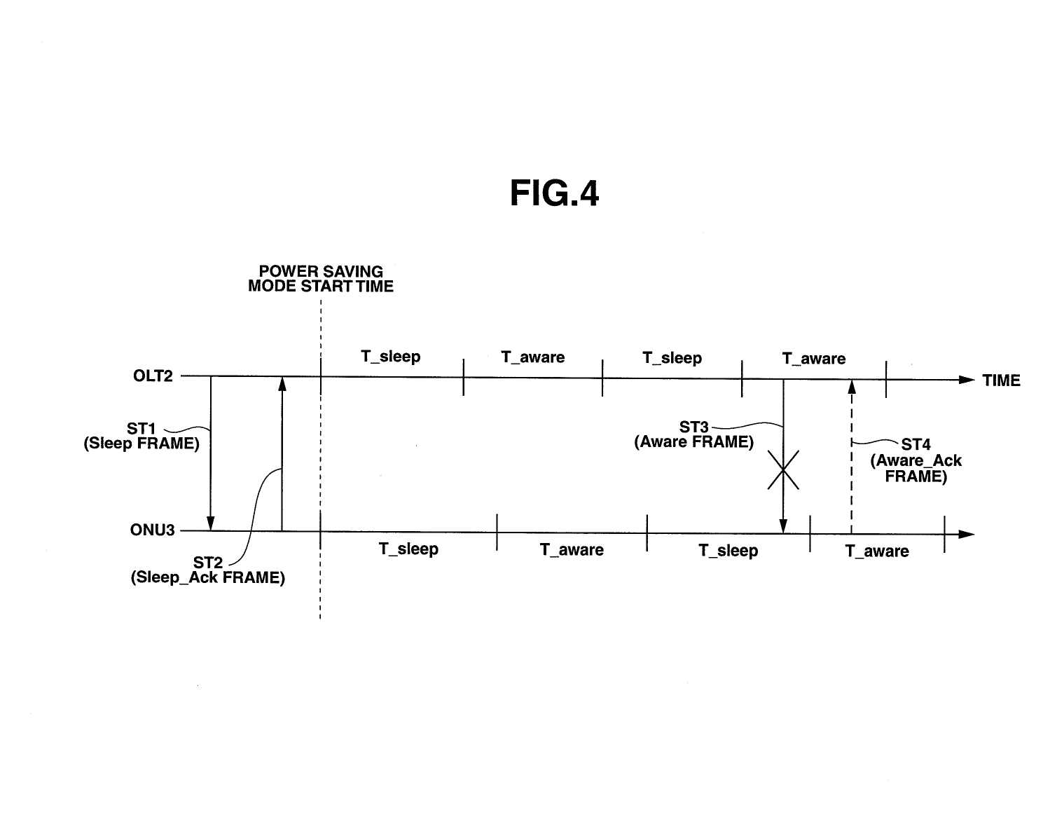

FIG. 5 is a view for explaining a case in which correction is performed in consideration of an error when returning from the power saving mode to the normal mode in a communication process according to the first embodiment;

FIG. 6 is a block diagram showing the circuit arrangements of an OLT and an ONU corresponding to the first embodiment;

FIG. 7 is a timing chart showing examples of the operations of an OLT and an ONU corresponding to the first embodiment;

FIG. 8 is a state transition diagram for explaining the processing procedure of a parent station power control unit according to the first embodiment;

FIG. 9 is a block diagram showing the arrangement of a parent station period measurement unit according to the first embodiment;

FIG. 10 is a state transition diagram for explaining the processing procedure of a child station power control unit according to the first embodiment;

FIG. 11 is a block diagram showing the arrangement of a child station period measurement unit according to the first embodiment;

FIG. 12 is a view for explaining a case in which correction is performed in consideration of an error when returning from the power saving mode to the normal mode in a communication process according to the second embodiment;

FIG. 13 is a block diagram showing the circuit arrangements of an OLT and an ONU corresponding to the second embodiment;

FIG. 14 is a block diagram showing the arrangement of a child station period measurement unit according to the second embodiment;

FIG. 15 is a view for explaining a case in which correction is performed in consideration of an error when returning from the power saving mode to the normal mode in a communication process according to the third embodiment;

FIG. 16 is a block diagram showing the circuit arrangements of an OLT and an ONU corresponding to the third embodiment;

FIG. 17 is a block diagram showing the arrangement of a child station period measurement unit according to the third embodiment;

FIG. 18 is a view for explaining a case in which a return from the power saving mode to the normal mode is impossible in a communication process according to the fourth embodiment;

FIG. 19 is a view for explaining a case in which correction is performed in consideration of an error when returning from the power saving mode to the normal mode in the communication process according to the fourth embodiment;

FIG. 20 is a block diagram showing the circuit arrangements of an OLT and an ONU corresponding to the fourth embodiment;

FIG. 21 is a block diagram showing the arrangement of a child station period measurement unit according to the fourth embodiment;

FIG. 22 is a view for explaining a case in which correction is performed in consideration of an error when returning from the power saving mode to the normal mode in a communication process according to the fifth embodiment;

FIG. 23 is a block diagram showing the circuit arrangements of an OLT and an ONU corresponding to the fifth embodiment;

FIG. 24 is a view for explaining a case in which correction is performed on an OLT side when returning from the power saving mode to the normal mode in a communication process according to the sixth embodiment; and

FIG. 25 is a block diagram showing the circuit arrangements of an OLT and an ONU corresponding to the sixth embodiment.

### BEST MODE FOR CARRYING OUT THE INVENTION

### (1) First Embodiment

In the first embodiment, a case in which, for example, one OLT and one ONU are provided will be described.

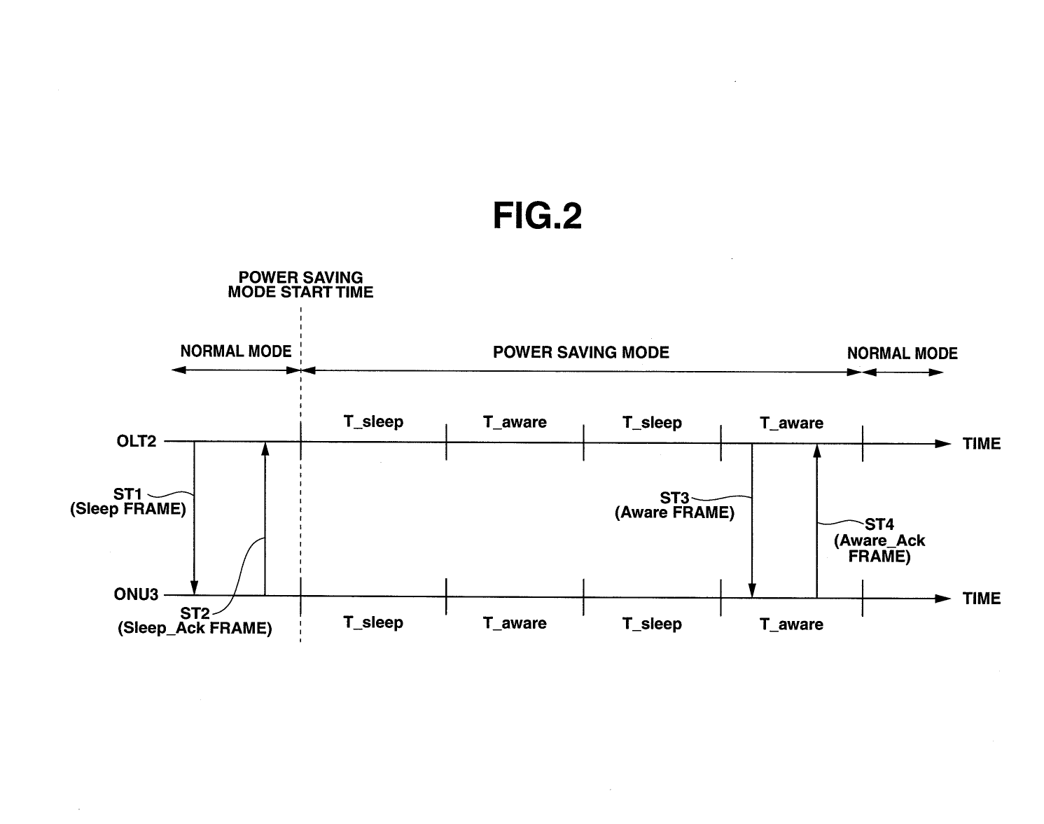

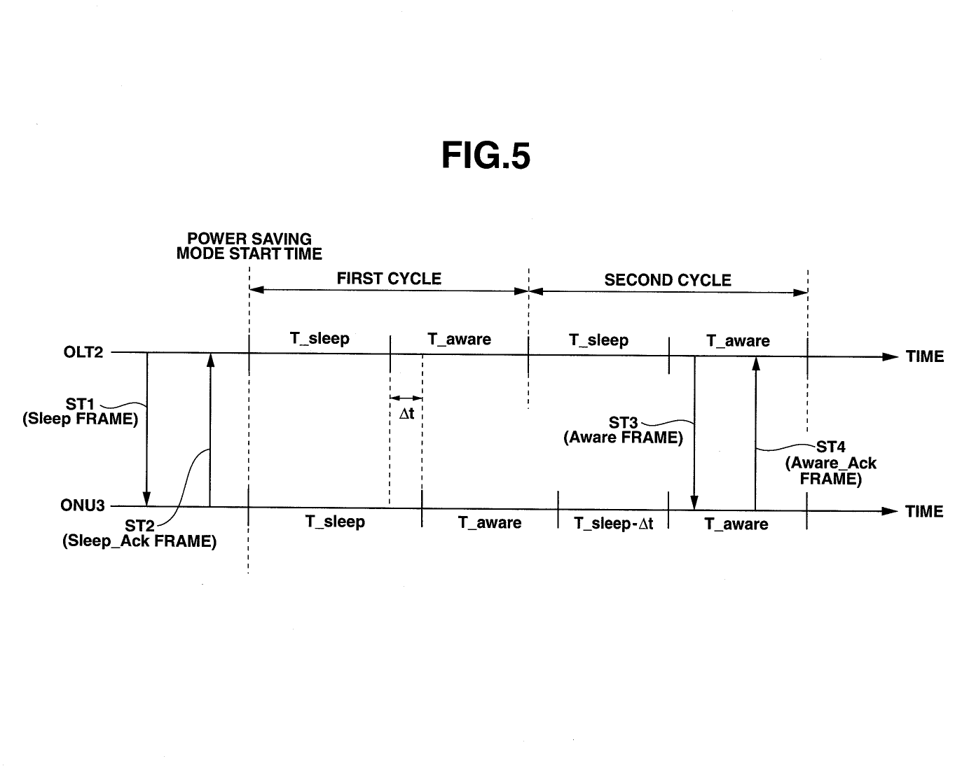

As shown in FIG. 5 in which the same reference numerals as in FIG. 2 denote the corresponding parts, according to the communication process of a PON system 1 of the first embodiment, a time error (Δt) that occurs during the Sleep period of an ONU 3 between the local time of the ONU 3 and the reference time of an OLT 2 is detected in the Aware period of the ONU 3 in which control frame transmission/reception is possible between the OLT 2 and the ONU 3, and time synchronization with the OLT 2 can be established.

In the communication process according to the first embodiment, the Sleep period of the ONU 3 in the next cycle after the establishment of time synchronization with the OLT 2 is set to “T_sleep-Δt”, thereby correcting the error (Δt).

Note that although FIG. 5 shows a case in which the error (Δt) is positive, the error (Δt) may be negative. The error (Δt) is sufficiently small relative to the Sleep period or the Aware period. The first embodiment solves the problem of the error (Δt) that accumulates and attains a large value along with the elapse of time.

(1-1) Circuit Arrangements of OLT And ONU of First Embodiment

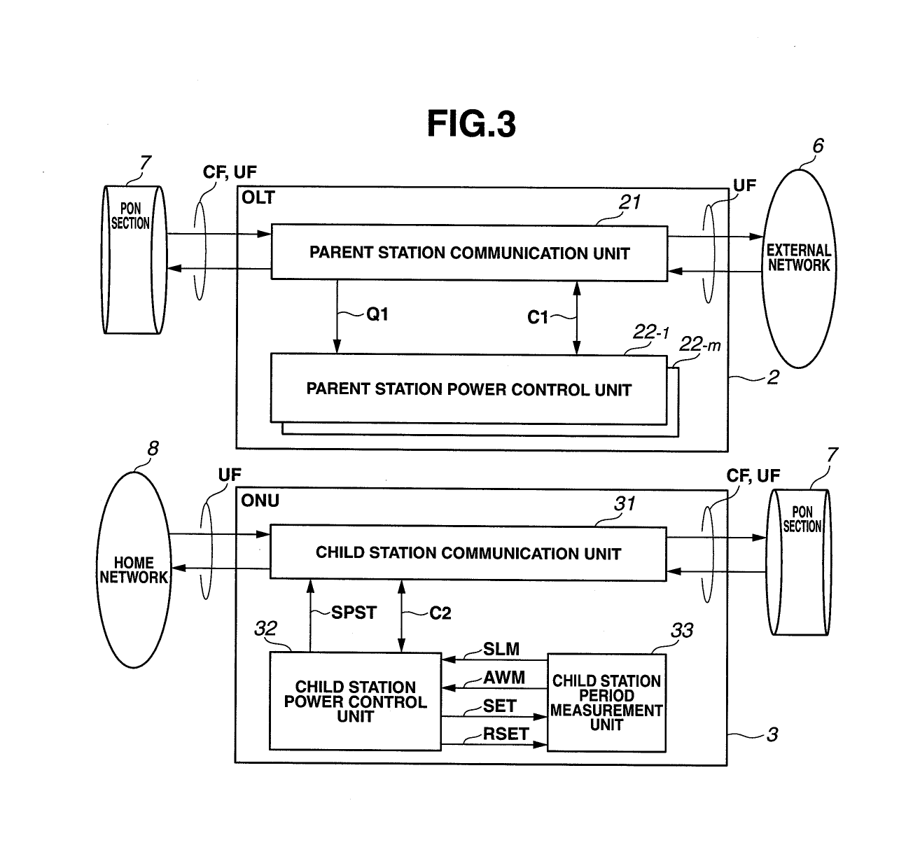

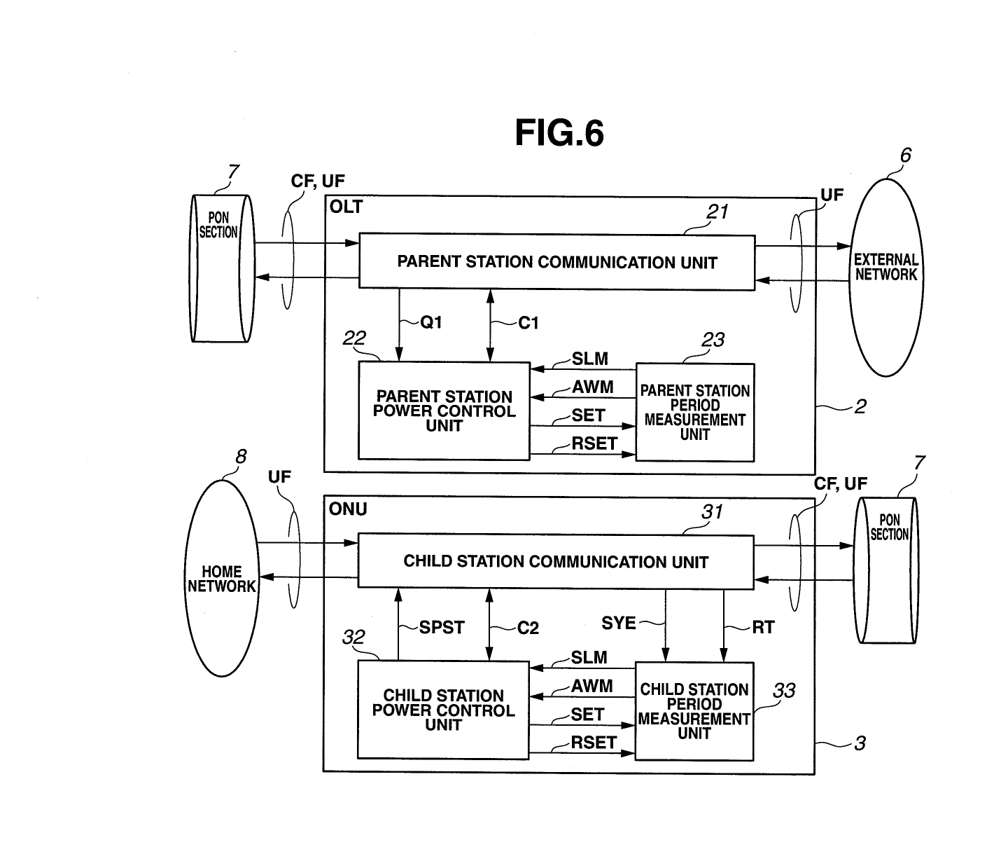

As shown in FIG. 6 in which the same reference numerals as in FIG. 3 denote the corresponding parts, the OLT 2 implements a predetermined protocol like the one described above in a parent station communication unit 21. The OLT 2 maintains connection to the ONU 3 while periodically transmitting a control frame CF from the parent station communication unit 21 to the ONU 3 via a PON section 7 to notify it of the reference time, and transmits a user frame UF input from an external network 6 to the ONU 3 via the parent station communication unit 21 and the PON section 7. The OLT 2 also transmits the user frame UF, which is input from a home network 8 to the ONU 3 and transmitted from the ONU 3 via the PON section 7, to the external network 6 via the parent station communication unit 21.

A parent station power control unit 22 of the OLT 2 corresponds to the ONU 3 connected to the OLT 2, and controls whether the ONU 3 should be in the power saving mode or the normal mode. In the OLT 2, the parent station power control unit 22 receives traffic Q1 of the corresponding ONU 3 from the parent station communication unit 21. The parent station power control unit 22 decides, based on the traffic Q1, whether to set the ONU 3 in the power saving mode. The parent station power control unit 22 of the OLT 2 instructs the parent station communication unit 21 to transmit the control frame CF by a control signal C1. The parent station communication unit 21 generates the control frame CF such as a Sleep frame or Aware frame in accordance with the transmission instruction and transmits the control frame CF to the ONU 3.

In addition to this arrangement, the OLT 2 is newly provided with a parent station period measurement unit 23 connected to the parent station power control unit 22. The parent station period measurement unit 23 measures the Sleep period and the Aware period of the ONU 3, like a child station period measurement unit 33 of the ONU 3. The parent station period measurement unit 23 outputs a Sleep state signal SLM to the parent station power control unit 22 when the ONU 3 is in the Sleep period, and outputs an Aware state signal AWM to the parent station power control unit 22 when the ONU 3 is in the Aware period.

The parent station power control unit 22 of the OLT 2 determines the state of the ONU 3 based on the Sleep state signal SLM or the Aware state signal AWM supplied from the parent station period measurement unit 23. When the ONU 3 is in the Aware period, the parent station power control unit 22 instructs the parent station communication unit 21 to output, to the ONU 3, the control frame (Aware frame) CF to instruct a return to the normal mode.

On the other hand, the ONU 3 includes a child station communication unit 31, a child station power control unit 32, and the child station period measurement unit 33. The ONU 3 implements a predetermined communication protocol in the child station communication unit 31, like the OLT 2. The ONU 3 maintains connection to the OLT 2 while establishing time synchronization with the OLT 2 based on a reference time transmitted from the OLT 2. The ONU 3 transmits the user frame UF, which is input from the home network 8, from the child station communication unit 31 to the OLT 2. In addition, the ONU 3 transmits the user frame UF, which is input from the OLT 2 via the PON section 7, from the child station communication unit 31 to the home network 8. When the ONU 3 shifts to the Sleep state or the Aware state, the child station communication unit 31 of the ONU 3 controls stop or activation of the communication function by a stop/activation signal SPST input from the child station power control unit 32.

The child station power control unit 32 of the ONU 3 transmits/receives the control frame CF to/from the OLT 2 via the child station communication unit 31, and manages whether the ONU 3 should be in the power saving mode or the normal mode. More specifically, upon receiving the control frame (Sleep frame) CF from the OLT 2, the child station communication unit 31 of the ONU 3 notifies the child station power control unit 32 of the contents of the control frame (Sleep frame) CF by a control signal C2. As a result, the child station power control unit 32 of the ONU 3 shifts from the normal mode to the power saving mode based on the control signal C2 and repeats the Sleep state and the Aware state in a predetermined period. The child station period measurement unit 33 measures the Sleep period and the Aware period.

In the ONU the child station power control unit 32 outputs a set signal SET and a reset signal RSET to the child station period measurement unit 33, and the child station period measurement unit 33 outputs the Sleep state signal SLM and the Aware state signal AWM to the child station power control unit 32. The set signal SET causes the child station period measurement unit 33 to start measuring the Sleep period and the Aware period. The reset signal RSET causes the child station period measurement unit 33 to stop the measurement. The Sleep state signal SLM is output in the Sleep period. The Aware state signal AWM is output in the Aware period.

In actuality, when the ONU 3 shifts from the normal mode to the power saving mode, the child station power control unit 32 outputs the set signal SET to the child station period measurement unit 33, and the child station period measurement unit 33 starts measuring the Sleep period and the Aware period. The ONU 3 causes the child station power control unit 32 to determine, based on the Sleep state signal SLM and the Aware state signal AWM from the child station period measurement unit 33, whether the ONU 3 is in the Sleep state or the Aware state and output the stop/activation signal SPST to the child station communication unit 31 to instruct stop/activation of the communication function.

In addition to this arrangement, the ONU 3 outputs a local time RT and a synchronization completion signal SYE from the child station communication unit 31 to the child station period measurement unit 33. The local time RT during the Sleep period is uniquely generated in accordance with the internal clock of the ONU 3. A slight clock deviation occurs between the local time RT and the reference time from the OLT 2. The synchronization completion signal SYE is output from the child station communication unit 31 to the child station period measurement unit 33 when the ONU 3 shifts from the Sleep state to the Aware state, and time synchronization between the local time RT and the reference time from the OLT 2 is completed.

The child station period measurement unit 33 of the ONU 3 detects the error (Lt) that occurs between the local time RT and the reference time from the OLT 2 during the Sleep period in the preceding cycle. The child station period measurement unit 33 corrects the Sleep period to be measured in the next cycle from preset “T_sleep” to “T_sleep-Δt”, and then measures the Sleep period in the next cycle.

In actuality, the ONU 3 first causes the child station communication unit 31 to always output the local time RT to the child station period measurement unit 33. When the ONU 3 is in the Aware period, the local time RT maintains synchronization with the OLT 2 by reception of the control frame CF from the OLT 2. However, during the Sleep period of the ONU 3, the error (Δt) occurs between the local time RT of the ONU 3 and the reference time of the OLT 2.

When the ONU 3 shifts from the Sleep period to the Aware period, the local time RT of the ONU 3 and the reference time of the OLT 2 are synchronized by the control frame CF sent from the OLT 2. At this time, the local time of the ONU 3 delayed so far advances by the error (Δt).

At this time, the child station communication unit 31 of the ONU 3 outputs the synchronization completion signal SYE to the child station period measurement unit 33 together with the local time RT synchronized with the OLT 2. The child station period measurement unit 33 of the ONU 3 calculates the difference between the local time (synchronized with the reference time of the OLT 2) RT when the synchronization completion signal SYE was input and the immediately preceding local time RT, thereby obtaining the error (Δt). Finally, the child station period measurement unit 33 of the ONU 3 changes the preset Sleep period “T_sleep” to “T_sleep-Δt” based on the error (Δt) obtained a little while ago, thereby completing correction of the error (Δt).

(1-2) Examples of Operations of OLT and ONU of First Embodiment

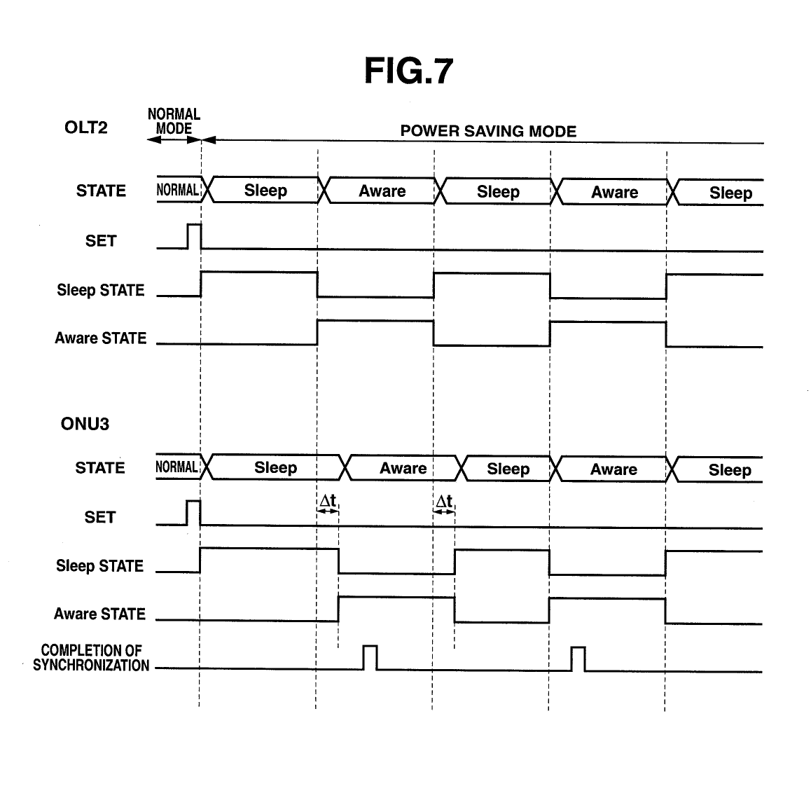

As shown in FIG. 7, when the ONU 3 shifts from the normal mode to the power saving mode, the parent station power control unit 22 of the OLT 2 inputs the set signal SET to the parent station period measurement unit 23. The OLT 2 sets the power saving mode while switching the Sleep state and the Aware state at a predetermined cycle, and starts measuring the Sleep period and the Aware period. To the contrary, when the ONU 3 returns from the power saving mode to the normal mode, the parent station power control unit 22 of the OLT 2 inputs the reset signal RSET to the parent station period measurement unit 23.

On the other hand, the ONU 3 operates in the same way as the OLT 2 until shifting to the power saving mode by the set signal SET. However, the error (Δt) between the reference time of the OLT 2 and the local time RT of the ONU 3 occurs during the Sleep period. When the ONU 3 shifts from the Sleep period to the Aware period, and time synchronization between the OLT 2 and the ONU 3 is completed, the child station communication unit 31 outputs the synchronization completion signal SYE to the child station period measurement unit 33.

The child station period measurement unit 33 of the ONU 3 calculates the difference between the local time (synchronized with the reference time of the OLT 2) RT when the synchronization completion signal SYE was input and the immediately preceding local time (not synchronized with the reference time of the OLT 2) RT based on the synchronization completion signal SYE, thereby detecting the error (Δt). The child station period measurement unit 33 changes the next Sleep period to “T_sleep-Δt”, thereby applying correction corresponding to the error (Δt). For this reason, the next Sleep period of the ONU 3 becomes shorter than the Sleep period of the OLT 2 by the error (Δt). This can prevent the error (Δt) from accumulating every time the cycle repeats subsequently.

(1-3) Processing Procedure of Parent Station Power Control Unit of OLT

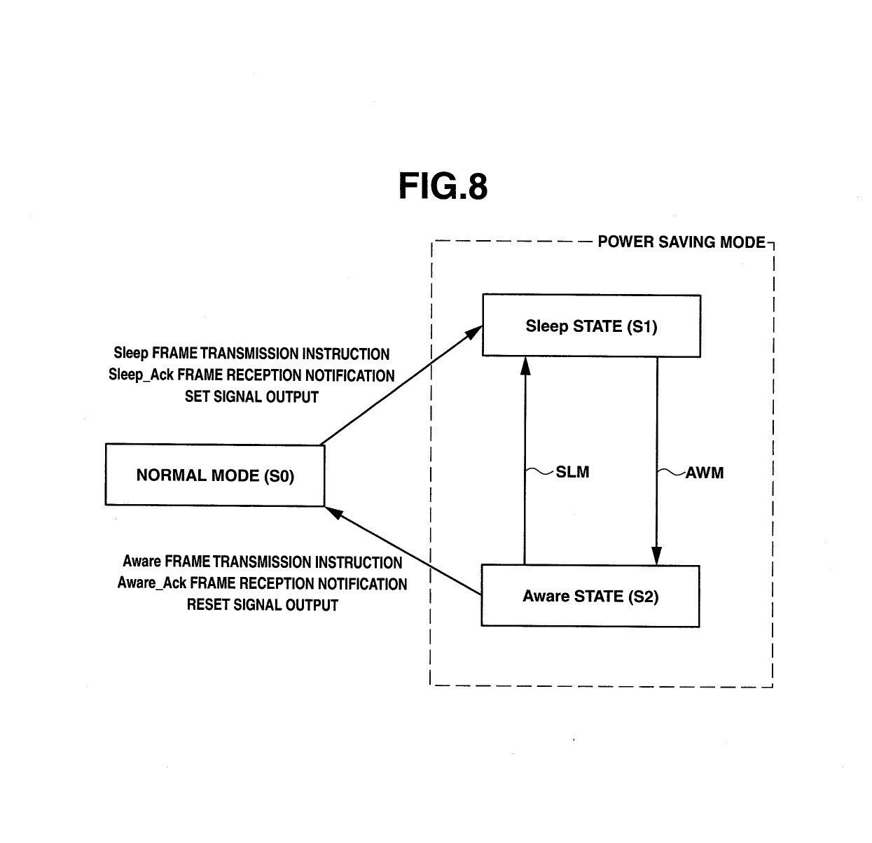

As shown in FIG. 8, the parent station power control unit 22 of the OLT 2 is configured to perform processing by three states, a normal mode (S0), and a Sleep state (S1) and Aware state (S2) of the power saving mode.

In this case, the parent station power control unit 22 of the OLT 2 starts from the normal mode (S0).

In the normal mode (S0), upon deciding to shift a certain ONU 3 to the power saving mode based on the traffic or the like, the parent station power control unit 22 outputs the control signal C1 of Sleep frame transmission instruction to the parent station communication unit 21 to transmit a Sleep frame to the ONU 3. Upon receiving, from the parent station communication unit 21, the control signal C1 of Sleep_Ack frame reception notification representing that a Sleep_Ack frame has been received from the ONU 3, the parent station power control unit 22 outputs the set signal SET to the parent station period measurement unit 23 to make the OLT 2 transit to the Sleep state (S1). Next, upon receiving the Aware state signal AWM from the parent station period measurement unit 23, the parent station power control unit 22 makes the OLT 2 transit to the Aware state (S2).

When returning the ONU 3 from the power saving mode to the normal mode, in the Aware state (S2), the parent station power control unit 22 of the OLT 2 outputs the control signal C1 of Aware frame transmission instruction to the parent station communication unit 21 to transmit an Aware frame to the ONU 3. Upon receiving, from the parent station communication unit 21, the control signal C1 of Aware_Ack frame reception notification representing that an Aware_Ack frame has been received from the ONU 3, the parent station power control unit 22 transmits the reset signal RSET to the parent station period measurement unit 23 to make the OLT 2 transit from the Aware state (S2) of the power saving mode to the normal mode (S0).

Note that when the parent station power control unit 22 of the OLT 2 receives the Sleep state signal SLM from the parent station period measurement unit 23 in the Aware state (S2), the OLT 2 transmits from the Aware state (S2) to the Sleep state (S1). At this time, if transition to the normal mode (S0) and that to the Sleep state (S1) have simultaneously occurred in the Aware state (S2), the parent station power control unit 22 gives higher priority to transition to the normal mode (S0).

“Give higher priority” means that, for example, when transition to the normal mode (S0) and that to the Sleep state (S1) have simultaneously occurred, for example, the OLT 2 transmits the Aware frame to the ONU 3, waits for arrival of the Aware_Ack frame from the ONU 3 for a predetermined time, if the Aware_Ack frame has arrived, transits to the normal mode (S0), and if not, transits to the Sleep state (S1).

(1-4) Circuit Arrangement of Parent Station Period Measurement Unit of OLT

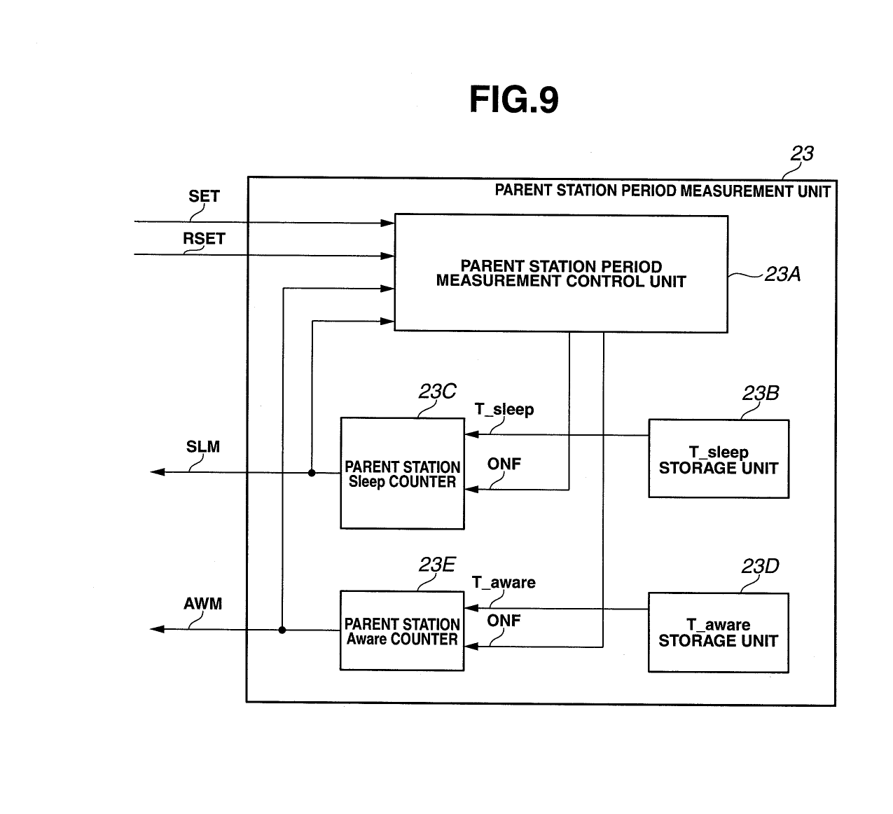

FIG. 9 shows the arrangement of the parent station period measurement unit 23 of the OLT 2. The parent station period measurement unit 23 includes a parent station period measurement control unit 23A, a T_sleep storage unit 23B, a parent station Sleep counter 23C, a T_aware storage unit 23D, and a parent station Aware counter 23E.

The T_sleep storage unit 23B of the parent station period measurement unit 23 stores the value “T_sleep” and outputs the value to the parent station Sleep counter 23C. Similarly, the T_aware storage unit 23D stores the value “T_aware” and outputs the value to the parent station Aware counter 23E.

The parent station Sleep counter 23C and the parent station Aware counter 23E measure the Sleep period and the Aware period, respectively. When the parent station Sleep counter 23C is counting, the period is the Sleep period, and the parent station Sleep counter 23C outputs the Sleep state signal SLM. When the parent station Aware counter 23E is counting, the period is the Aware period, and the parent station Aware counter 23E outputs the Aware state signal AWM.

The parent station Sleep counter 23C and the parent station Aware counter 23E are controlled by an ON/OFF signal ONF from the parent station period measurement control unit 23A. When the ON/OFF signal ONF is enabled, each of the parent station Sleep counter 23C and the parent station Aware counter 23E loads the input value and starts counting. On the other hand, when the ON/OFF signal ONF is disabled, each of the parent station Sleep counter 23C and the parent station Aware counter 23E is reset.

The parent station period measurement control unit 23A controls the ON/OFF signal ONF to be output to each of the parent station Sleep counter 23C and the parent station Aware counter 23E by the set signal SET and the reset signal RSET input from the parent station power control unit 22 (FIG. 6), the Sleep state signal SLM from the parent station Sleep counter 23C, and the Aware state signal AWM from the parent station Aware counter 23E.

Upon receiving the set signal SET indicating the start of the power saving mode from the parent station power control unit 22 (FIG. 6), the parent station period measurement control unit 23A enables the ON/OFF signal ONF to the parent station Sleep counter 23C, and starts measuring the Sleep period. When the Sleep period has ended, and the parent station Sleep counter 23C has stopped outputting the Sleep state signal SLM, the parent station period measurement control unit 23A disables the ON/OFF signal ONF to the parent station Sleep counter 23C. Then, the parent station period measurement control unit 23A enables the ON/OFF signal ONF to be output to the parent station Aware counter 23E, and starts measuring the Aware period. The parent station period measurement control unit 23A repeats this operation until receiving the reset signal RSET from the parent station power control unit 22 (FIG. 6). Upon receiving the reset signal RSET, the parent station period measurement control unit 23A disables the ON/OFF signal ONF to the parent station Sleep counter 23C and the parent station Aware counter 23E, and ends the measurement of the Sleep period and the Aware period.

(1-5) Processing Procedure of Child Station Power Control Unit of ONU

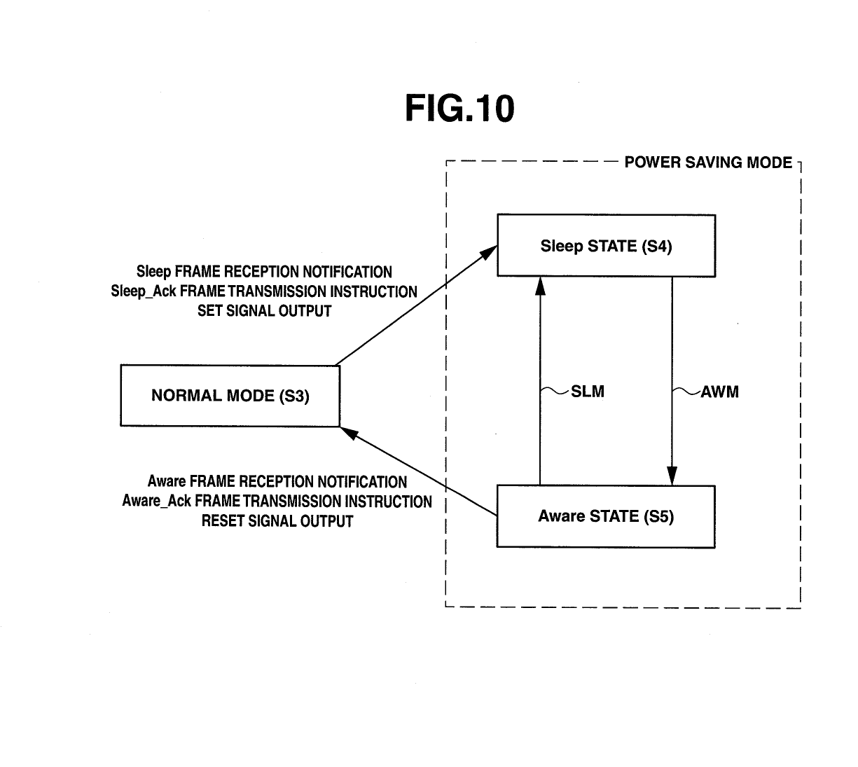

As shown in FIG. 10, the child station power control unit 32 of the ONU 3 is configured to perform processing by three states, a normal mode (S3), and a Sleep state (S4) and Aware state (S5) of the power saving mode.

In this case, this processing procedure is different from that of the parent station power control unit 22 of the OLT 2 in that when transiting from the normal mode (S3) to the Sleep state (S4) of the power saving mode, the child station power control unit 32 receives the Sleep frame from the OLT 2 and then transmits the Sleep_Ack frame to the OLT 2.

Additionally, when transiting from the Aware state (S5) of the power saving mode to the normal mode (S3), the child station power control unit 32 receives the Aware frame from the OLT 2 and then transmits the Aware_Ack frame to the OLT 2.

More specifically, when notified by the child station communication unit 31 of reception of the Sleep frame from the OLT 2, the child station power control unit 32 of the ONU 3 instructs the child station communication unit 31 by the control signal C2 to transmit the Sleep_Ack frame representing that the Sleep frame has been received. The child station power control unit 32 of the ONU 3 then outputs the set signal SET to the child station period measurement unit 33 and makes the ONU 3 transit from the normal mode (S3) to the Sleep state (S4).

When notified by the child station communication unit 31 of reception of the Aware frame from the OLT 2, the child station power control unit 32 of the ONU 3 instructs the child station communication unit 31 by the control signal C2 to transmit the Aware_Ack frame representing that the Aware frame has been received. The child station power control unit 32 of the ONU 3 then transmits the reset signal RSET to the child station period measurement unit 33 and makes the ONU 3 transit from the Aware state (S5) of the power saving mode to the normal mode (S3). Note that the rest of the processing of the child station power control unit 32 of the ONU 3 is the same as that of the parent station power control unit 22 of the OLT 2, and a description thereof will be omitted for the sake of convenience.

(1-6) Circuit Arrangement of Child Station Period Measurement Unit of ONU

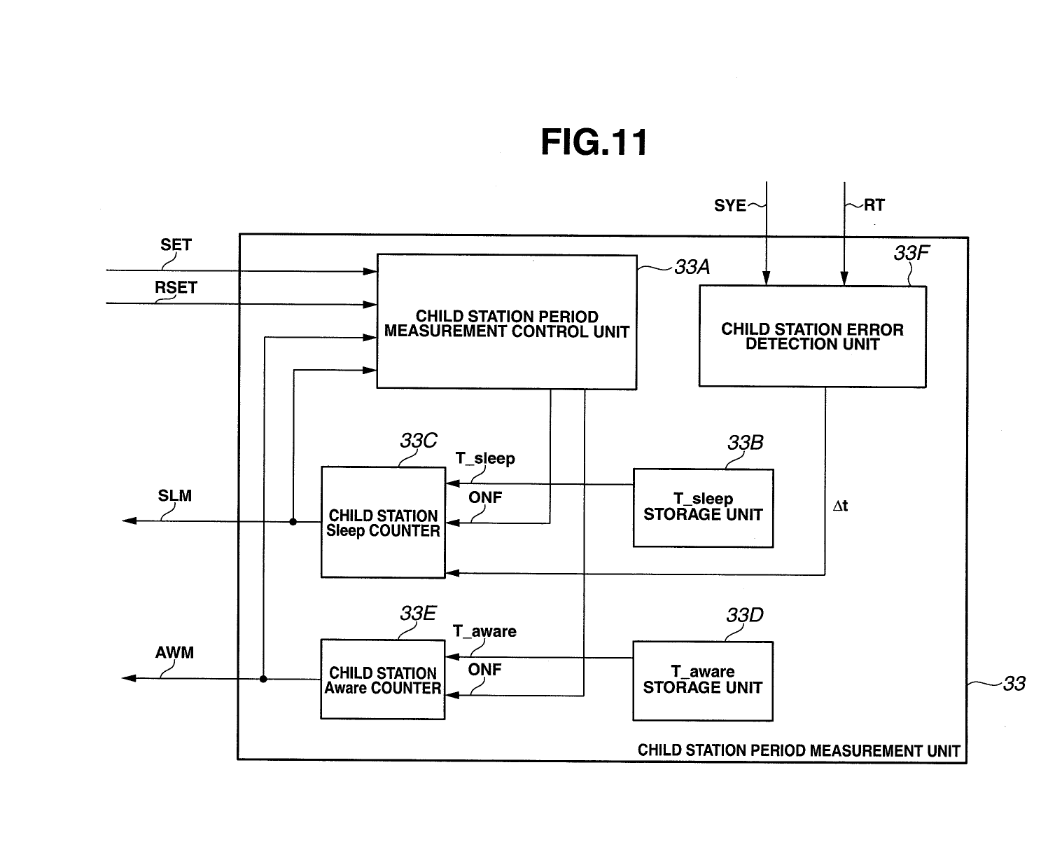

FIG. 11 shows the arrangement of the child station period measurement unit 33 of the ONU 3. The child station period measurement unit 33 includes a child station period measurement control unit 33A, a T_sleep storage unit 33B, a child station Sleep counter 33C, a T_aware storage unit 33D, a child station Aware counter 33E, and a child station error detection unit 33F. The child station period measurement unit 33 of the ONU 3 is different from the parent station period measurement unit 23 of the OLT 2 in that the child station error detection unit 33F is newly provided.

The child station error detection unit 33F calculates the error (Δt) between the OLT 2 and the ONU 3 based on the difference between the local time (synchronized with the reference time of the OLT 2) RT when the synchronization completion signal SYE was input from the child station communication unit 31 (FIG. 6) and the immediately preceding local time (not synchronized with the reference time of the OLT 2) RT, and outputs the error (Δt) to the child station Sleep counter 33C. When ON/OFF signal ONF is enabled, the child station Sleep counter 33C subtracts the error (Δt) input from the child station error detection unit 33F from the value “T_sleep” input from the T_sleep storage unit 33B, and loads the resultant value as a count. The rest of the arrangement and processing is the same as that of the parent station period measurement unit 23, and a description thereof will be omitted for the sake of convenience.

(1-7) Functions and Effects of First Embodiment

With the above-described arrangement, the PON system 1 according to the first embodiment detects, in the Aware period of the ONU 3 in which transmission/reception of the control frame CF is enabled between the OLT 2 and the ONU 3, the time error (Δt) that occurs with respect to the OLT 2 during the Sleep period of the ONU 3.

In the PON system 1, the Sleep period of the next cycle in the ONU 3 after the embodiment of time synchronization with the OLT 2 is set to “T_sleep-Δt”, thereby correcting the error (Δt) between the reference clock of the OLT 2 and the local time RT of the ONU 3.

In the ONU 3, the next Sleep period becomes shorter than the Sleep period of the OLT 2 by the error (Δt). Even when the cycle repeats subsequently, the error (Δt) between the reference clock of the OLT 2 and the local time RT of the ONU 3 can be prevented from accumulating along with the elapse of time because the error (Δt) has already been corrected. The PON system 1 can thus decrease the number of times of causing the OLT 2 to transmit the control frame of return instruction, as compared to the conventional method that does not correct the error (Δt). It is therefore possible to reduce the load on the OLT 2 and thus prevent an increase in the power consumption without lowering the band utilization efficiency.

According to the above-described arrangement, the PON system 1 detects, in the first Aware period of the ONU 3, the time error (Δt) that occurs with respect to the OLT 2 during the Sleep period of the ONU 3. The Sleep period of the next cycle is set to “T_sleep-Δt” in consideration of the error (Δt), thereby correcting the error (Δt) between the reference clock of the OLT 2 and the local time RT of the ONU 3 and immediately establishing time synchronization. This makes it possible to reliably return the ONU 3 from the power saving mode to the normal mode without increasing the load on the OLT 2.

(1-8) Other Embodiments Corresponding to First Embodiment

Note that in the above-described first embodiment, a case has been explained in which the Sleep period of the ONU 3 is set to “T_sleep-Δt”, thereby correcting the error (Δt). However, the present invention is not limited to this and need only correct the error (Δt) in one cycle of “T_sleep” and “T_aware”. Hence, for example, “T_aware-Δt” may be set, or “T_sleep-Δt/2” and “T_aware-Δt/2” may be set.

In the above-described first embodiment, a case has been explained in which one ONU 3 is connected to the OLT 2. However, the present invention is not limited to this, and n (1≦n≦m) ONUs can be controlled by preparing the parent station power control units 22 and the parent station period measurement units 23 of the OLT 2 as many as the ONUs 3 to be connected.

In the above-described first embodiment, a case has been explained in which the values of “T_sleep” and “T_aware” in the power saving mode are preset, and the T_sleep storage unit 33B and the T_aware storage unit 33D of the child station period measurement unit 33 store the values. However, the present invention is not limited to this, and the values of “T_sleep” and “T_aware” may be determined before the shift to the Sleep period in each cycle.

For example, in the Aware period of each cycle, the OLT 2 may notify the ONU 3 of the values of “T_sleep” and “T_aware” in the next cycle by the control frame CF, and the ONU 3 may shift to the Sleep period after setting the values. In this case, the child station period measurement unit 33 need not always include the T_sleep storage unit 33B and the T_aware storage unit 33D.

### (2) Second Embodiment

In the second embodiment as well, a case in which, for example, one OLT and one ONU are provided will be described.

In the first embodiment, the ONU 3 defects the time error (Δt) with respect to the OLT 2 and applies correction of the error (Δt) to the preset counts of the Sleep period and the Aware period.

In the communication process of a PON system 1 according to the second embodiment, however, an OLT 2 notifies an ONU 3 of the end times of the Sleep period and the Aware period (to be referred to as a Sleep period end time and an Aware period end time, respectively, hereinafter) by a control frame CF. When a local time RT of the ONU 3 has passed the Sleep period end time and the Aware period end time notified by the OLT 2, the ONU 3 ends the Sleep period and the Aware period. Note that in the second embodiment, the OLT 2 notifies the ONU 3 of the Sleep period end time and the Aware period end time of the (y+1)th cycle by the control frame (to be referred to as an end time notification frame hereinafter) CF in the Aware period of the yth cycle.

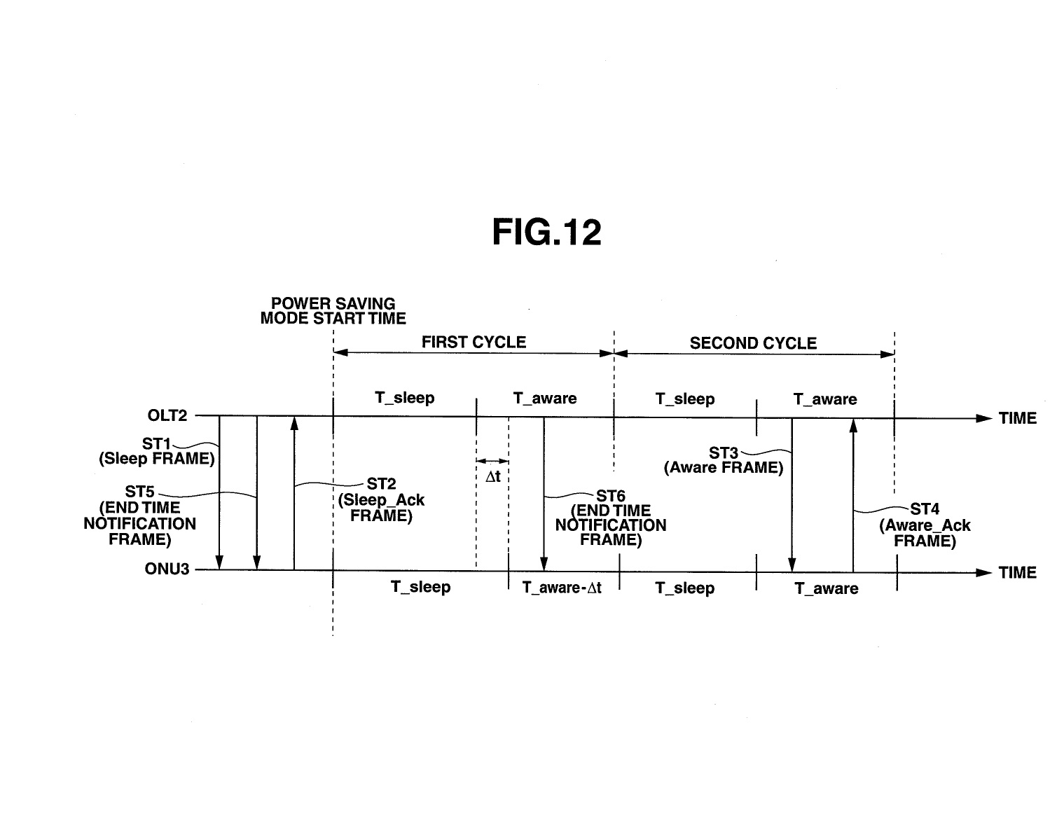

As shown in FIG. 12 in which the same reference numerals as in FIG. 5 denote the corresponding parts, the communication process until the OLT 2 transmits the Sleep frame to the ONU 3 is the same as the communication process (FIG. 5) of the first embodiment. The OLT 2 further notifies the ONU 3 of the Sleep period end time and the Aware period end time of the first cycle by the end time notification frames at times of steps ST5 and ST6.

Upon receiving the control frames (Sleep frame and end time notification frame) CF, the ONU 3 transmits a Sleep_Ack frame to the OLT 2 and shifts to the Sleep period after setting the Sleep period end time and the Aware period end time. When the local time RT has passed the Sleep period end time, the ONU 3 shifts to the Aware period. The reference time of the OLT 2 and the local time RT of the ONU 3 move on in different ways due to the clock deviation during the Sleep period. For this reason, the shift to the Aware period delays by an error (Δt) from the reference time of the OLT 2.

That is, the local time of the ONU 3 delays from the reference time of the OLT 2 by the error (Δt). In the Aware period, however, the ONU 3 can receive the control frame CF for time synchronization from the OLT 2 and thus establish synchronization with the reference time of the OLT 2. That is, at this time, the local time RT of the ONU 3 advances by the error (Δt).

The Aware period of the ONU 3 thus becomes shorter than the Aware period of the OLT 2 by the error (Δt) (T_aware-Δt). In the communication process of the second embodiment, this procedure is repeated in every cycle. In this communication process, when time synchronization is established between the OLT 2 and the ONU 3, correction of the error (Δt) is automatically applied to the local time RT of the ONU 3. For this reason, the same effects as in the first embodiment can effectively be obtained. Note that in the communication process of the second embodiment as well, the return method from the power saving mode to the normal mode is the same as in the communication process (FIG. 5) of the first embodiment, and a description thereof will be omitted for the sake of convenience.

Note that although FIG. 12 shows a case in which the error (Δt) is positive, the error (Δt) may be negative. The error (Δt) is sufficiently small relative to the Sleep period or the Aware period. Even the second embodiment solves the problem of the error (Δt) that accumulates and attains a large value along with the elapse of time.

(2-1) Circuit Arrangements of OLT And ONU of Second Embodiment

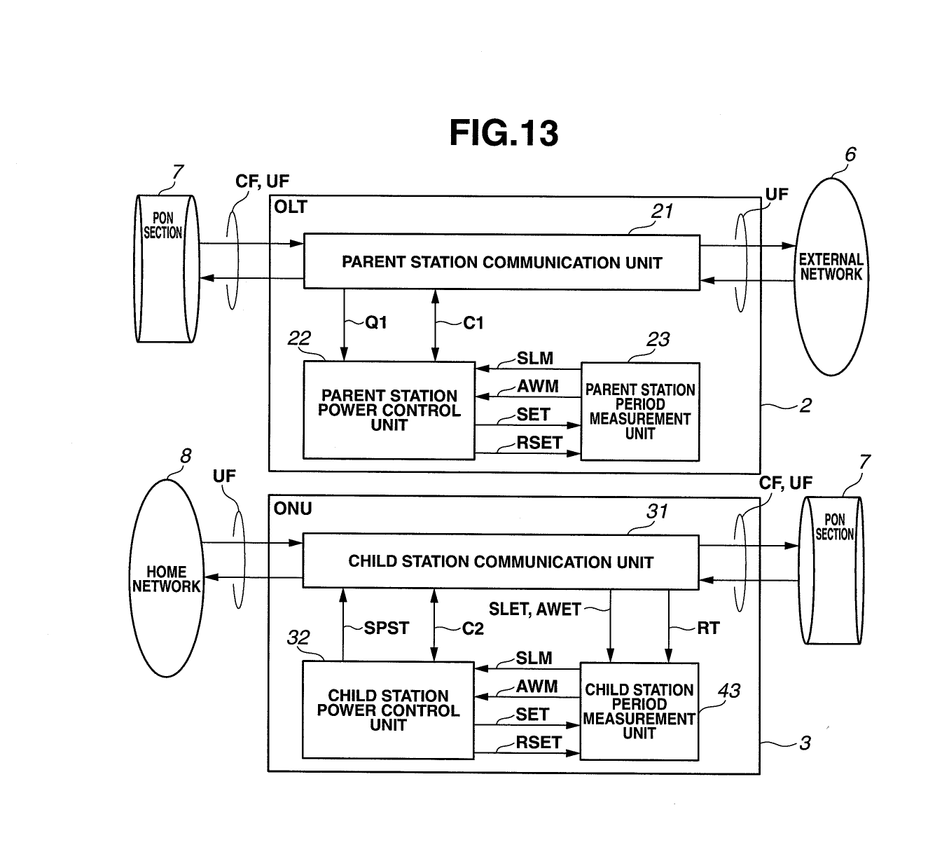

As shown in FIG. 13 in which the same reference numerals as in FIG. 6 denote the corresponding parts, the OLT 2 has the same arrangement as in the first embodiment except that a parent station power control unit 22 notifies the ONU 3 of the Sleep period end time and the Aware period end time by the control frame (end time notification frame) CF. Note that the rest of the arrangement of the OLT 2 is the same as in the first embodiment, and a description thereof will be omitted for the sake of convenience.

Even the ONU 3 has the same arrangement as in the first embodiment except that a child station communication unit 31 outputs the Sleep period end time and the Aware period end time to a child station period measurement unit 43. Note that the rest of the arrangement of the ONU 3 is the same as in the first embodiment, and a description thereof will be omitted for the sake of convenience.

In the ONU 3 having the above-described arrangement, the child station period measurement unit 43 compares the local time RT of the ONU 3 with the Sleep period end time and the Aware period end time supplied from the child station communication unit 31, and judges the ends of the Sleep period and the Aware period.

(2-2) Circuit Arrangement of Child Station Period Measurement Unit of ONU

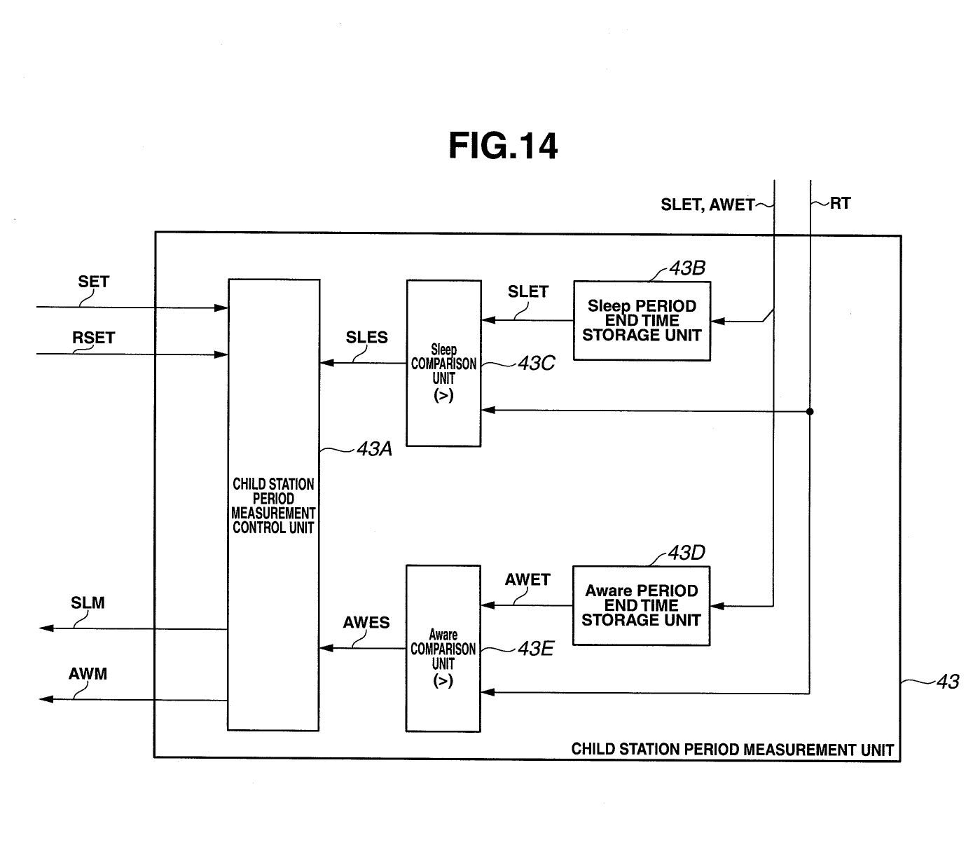

FIG. 14 shows the arrangement of the child station period measurement unit 43 of the ONU 3. The child station period measurement unit 43 of the ONU 3 according to the second embodiment includes a child station period measurement control unit 43A, a Sleep period end time storage unit 43B, a Sleep comparison unit 43C, an Aware period end time storage unit 43D, and an Aware comparison unit 43E.

The child station period measurement unit 43 stores a Sleep period end time SLET input from the child station communication unit 31 (FIG. 13) in the Sleep period end time storage unit 43B and also stores an Aware period end time AWET in the Aware period end time storage unit 43D.

The child station period measurement unit 43 causes the Sleep comparison unit 43C to compare the local time RT of the ONU 3 with the Sleep period end time SLET and output a Sleep period end signal SLES to the child station period measurement control unit 43A when the local time RT has passed the Sleep period end time SLET. Similarly, the child station period measurement unit 43 causes the Aware comparison unit 43E to compare the local time RT of the ONU 3 with the Aware period end time AWET and output an Aware period end signal AWES to the child station period measurement control unit 43A when the local time RT has passed the Aware period end time AWET.

The child station period measurement control unit 43A outputs, to the child station power control unit 32, a Sleep state signal SLM representing that the ONU 3 is in the Sleep state and an Aware state signal AWM representing that the ONU 3 is in the Aware state in accordance with a set signal SET and a reset signal RSET input from the child station power control unit 32 (FIG. 13), and the Sleep period end signal SLES and the Aware period end signal AWES input from the Sleep comparison unit 43C and the Aware comparison unit 43E.

(2-3) Functions and Effects of Second Embodiment

With the above-described arrangement, to eliminate the time error (Δt) that occurs with respect to the OLT 2 during the Sleep period of the ONU 3, the PON system 1 according to the second embodiment receives the control frame CF for time synchronization from the OLT 2 in the next Aware period in which transmission/reception of the control frame CF is enabled between the OLT 2 and the ONU 3, and synchronizes the reference time of the OLT 2 with the local time RT of the ONU 3, thereby advancing the local time of the ONU 3 by the error (Δt).

As a result, the Aware period of the ONU 3 becomes shorter than the Aware period of the OLT 2 by the error (Δt) (“T_aware-Δt”). Hence, the reference clock of the OLT 2 matches the local time RT of the ONU 3, thus completing correction of the error (Δt).

The ONU 3 receives the control frame CF for time synchronization from the OLT 2 and thus makes the reference clock of the OLT 2 match the local time RT of the ONU 3 and corrects the error (Δt) in every cycle. Hence, the error (Δt) can be prevented from accumulating along with the elapse of time. The PON system 1 can thus decrease the number of times of causing the OLT 2 to transmit the control frame of return instruction, as compared to the conventional method that does not correct the error (Δt). It is therefore possible to reduce the load on the OLT 2 and thus prevent an increase in the power consumption without lowering the band utilization efficiency.

According to the above-described arrangement, in the PON system 1, the control frame CF for time synchronization is received from the OLT 2, and the reference time of the OLT 2 is synchronized with the local time RT of the ONU 3 in the Aware period next to the Sleep period of the first cycle, that is, the next Aware period in which control frame transmission/reception is enabled between the OLT 2 and the ONU 3. The PON system 1 can thus advance the local time RT by the error (Δt) and eliminate the error (Δt) between the reference clock of the OLT 2 and the local time RT of the ONU 3. This makes it possible to reliably return the ONU 3 from the power saving mode to the normal mode without increasing the load on the OLT

(2-4) Other Embodiments Corresponding to Second Embodiment

Note that in the above-described second embodiment, a case has been explained in which the Aware period of the ONU 3 is set to “T_aware-Δt”, thereby correcting the error (Δt). However, the present invention is not limited to this, and “T_sleep-Δt” may be set.

For example, when “T_sleep-Δt” is set, only measurement of the Aware period is done by the child station Aware counter 33E, as in the first embodiment. The control frame CF for time synchronization is thus received from the OLT 2 at the timing of ending the Aware period, and the reference time of the OLT 2 and the local time RT of the ONU 3 are synchronized. As a result, the ONU 3 can advance the local time RT by the error (Δt), and the Sleep period of the ONU 3 becomes shorter than the Sleep period of the OLT 2 by the error (Δt) (“T_sleep-Δt”). For this reason, the reference clock of the OLT 2 can be made to match the local time RT of the ONU 3.

In the above-described second embodiment, a case has been explained in which one ONU 3 is connected to the OLT 2. However, the present invention is not limited to this, and n (1≦n≦m) ONUs can be controlled by preparing the parent station power control units 22 and the parent station period measurement units 23 of the OLT 2 as many as the ONUs 3 to be connected.

In the above-described second embodiment, a case has been explained in which the Sleep period end time storage unit 43B stores the Sleep period end time SLET input from the child station communication unit 31, and the Aware period end time storage unit 43D stores the Aware period end time AWET. However, the present invention is not limited to this, and the Sleep period end time SLET and the Aware period end time AWET may be predetermined. In this case, the ONU 3 need not always include the Sleep period end time storage unit 43B and the Aware period end time storage unit 43D.

In the above-described second embodiment, a case has been explained in which the child station communication unit 31 reads the Sleep period end time and the Aware period end time from the end time notification frame and outputs them to the child station period measurement unit 43. However, the present invention is not limited to this, and the parent station communication unit 21 may read the Sleep period end time SLET and the Aware period end time AWET from the control frame (end time notification frame) CF and output them to the child station period measurement unit 43.

### (3) Third Embodiment

In the third embodiment as well, a case in which, for example, one OLT and one ONU are provided will be described.

In the communication process of a PON system 1 according to the third embodiment as well, in a state in which an ONU 3 has a Sleep period end time SLET and an Aware period end time AWET, as in the second embodiment, when the local time of the ONU 3 has passed the Sleep period end time SLET and the Aware period end time AWET, the ONU 3 ends the Sleep period and the Aware period.

In the second embodiment, an OLT 2 notifies the ONU 3 of the Sleep period end time SLET and the Aware period end time AWET by a control frame CF. In the third embodiment, however, the ONU 3 calculates the Sleep period end time SLET and the Aware period end time AWET.

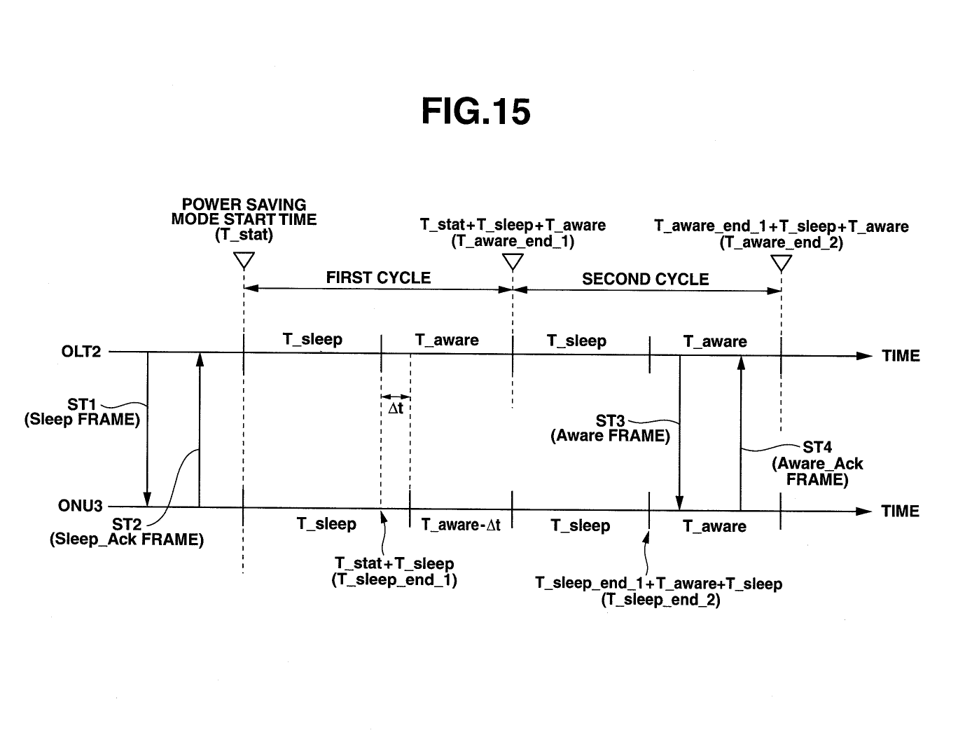

As shown in FIG. 15 in which the same reference numerals as in FIG. 12 denote the corresponding parts, according to the communication process of the PON system of the third embodiment, the ONU 3 ends the Sleep period with a delay of an error (Δt) from the OLT 2 in the first cycle, the reference time of the OLT 2 is synchronized with a local time RT of the ONU 3 in the Aware period, and the Aware period is set to “T_aware-Δt”, as in the second embodiment. The third embodiment is different from the second embodiment in that the OLT 2 does not transmit the control frame CF to notify the ONU 3 of the Sleep period end time SLET and the Aware period end time AWET.

In the communication process of the third embodiment, the ONU 3 calculates the Sleep period end time SLET and the Aware period end time AWET in each cycle. The method of calculating the Sleep period end time SLET and the Aware period end time AWET is as follows.

First, the power saving mode start time is set to (T_stat) in the local time RT, the Sleep period end time of the yth cycle is set to (T_sleep_end_y), and the Aware period end time is set to (T_aware_end_y). The Sleep period end time (T_sleep_end_{—}1) of the first cycle is calculated as “T_stat+T_sleep”, and the Aware period end time (T_aware_end_{—}1) is calculated as “T_stat+T_sleep+T_aware”.

The Sleep period end time (T_sleep_end_y) of the yth cycle is calculated as “T_sleep_end_(y−1)+T_aware+T_sleep”, and the Aware period end time (T_aware_end_y) is calculated as “T_aware_end_(y−1)+T_sleep+T_aware” hereafter. The method of calculating the Sleep period end time SLET and the Aware period end time AWET has been described above. Note that the power saving mode start time (T_stat) can be calculated as a time a predetermined time after the ONU 3 has transmitted a Sleep_Ack frame to the OLT 2. However, the method of deciding the power saving mode start time (T_stat) is not limited to this.

In the third embodiment as well, the error (Δt) occurs between the reference time of the OLT 2 and the local time RT of the ONU 3, as in the second embodiment. However, since synchronization is established between the reference time of the OLT 2 and the local time RT of the ONU 3 in the Aware period, correction of “T_aware-Δt” is performed in the Aware period to solve accumulating the error (Δt) every time the cycle repeats.

Note that although FIG. 15 also shows a case in which the error (Δt) is positive, the error (Δt) may be negative. The error (Δt) is sufficiently small relative to the Sleep period or the Aware period. Even the third embodiment solves the problem of the error (Δt) that accumulates and attains a large value along with the elapse of time.

(3-1) Circuit Arrangements of OLT And ONU of Third Embodiment

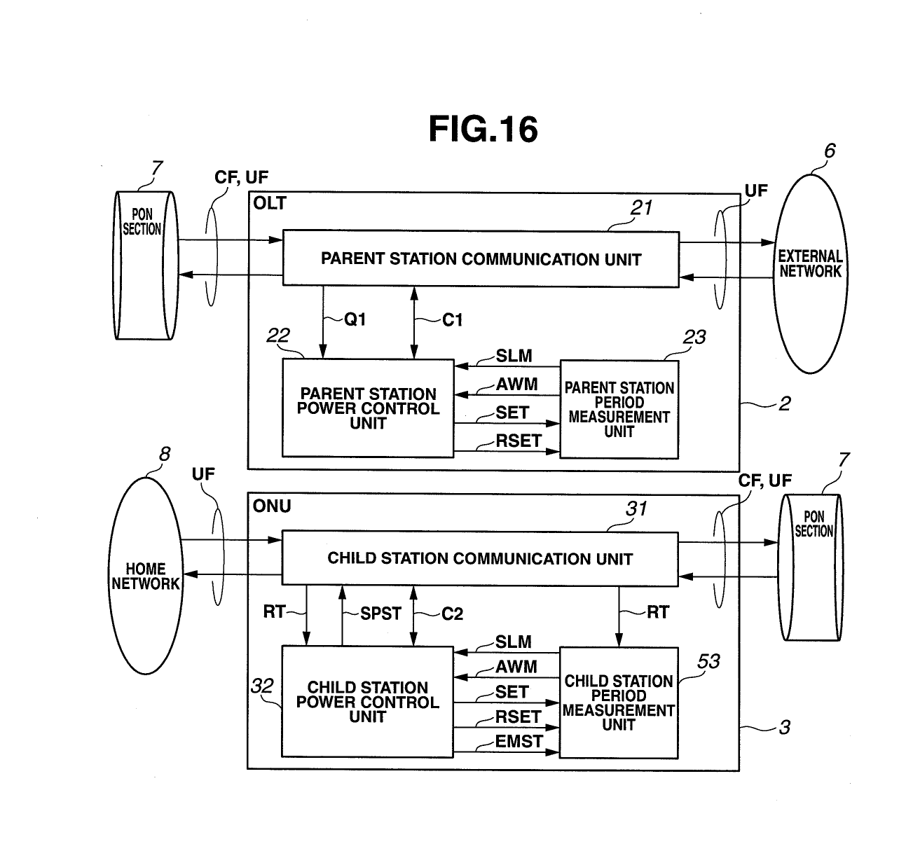

As shown in FIG. 16 in which the same reference numerals as in FIG. 13 denote the corresponding parts, the OLT 2 has the same arrangement as in the first embodiment, and a description thereof will be omitted here.

The ONU 3 basically has the same arrangement as in the second embodiment except that a child station communication unit 31 does not output the Sleep period end time SLET and the Aware period end time AWET to a child station period measurement unit 53, the child station communication unit 31 outputs the local time RT to a child station power control unit 32, and the child station power control unit 32 outputs a power saving mode start time EMST to the child station period measurement unit 53. Note that concerning the arrangement of the ONU 3, a description of the same parts as in the second embodiment will be omitted.

In the ONU 3 having the above-described arrangement, the child station power control unit 32 outputs not only a set signal SET but also the local time RT at that time simultaneously to the child station period measurement unit 53 as the power saving mode start time EMST (T_stat). Upon receiving the set signal SET from the child station power control unit 32, the child station period measurement unit 53 of the ONU 3 periodically calculates the Sleep period end time SLET and the Aware period end time AWET of each cycle based on the simultaneously input power saving mode start time EMST (T_stat) and preset “T_sleep” and “T_aware”. Note that upon receiving a reset signal RSET from the child station power control unit 32, the child station period measurement unit 53 erases the previously calculated Sleep period end time SLET and Aware period end time AWET.

(3-2) Circuit Arrangement of Child Station Period Measurement Unit of ONU

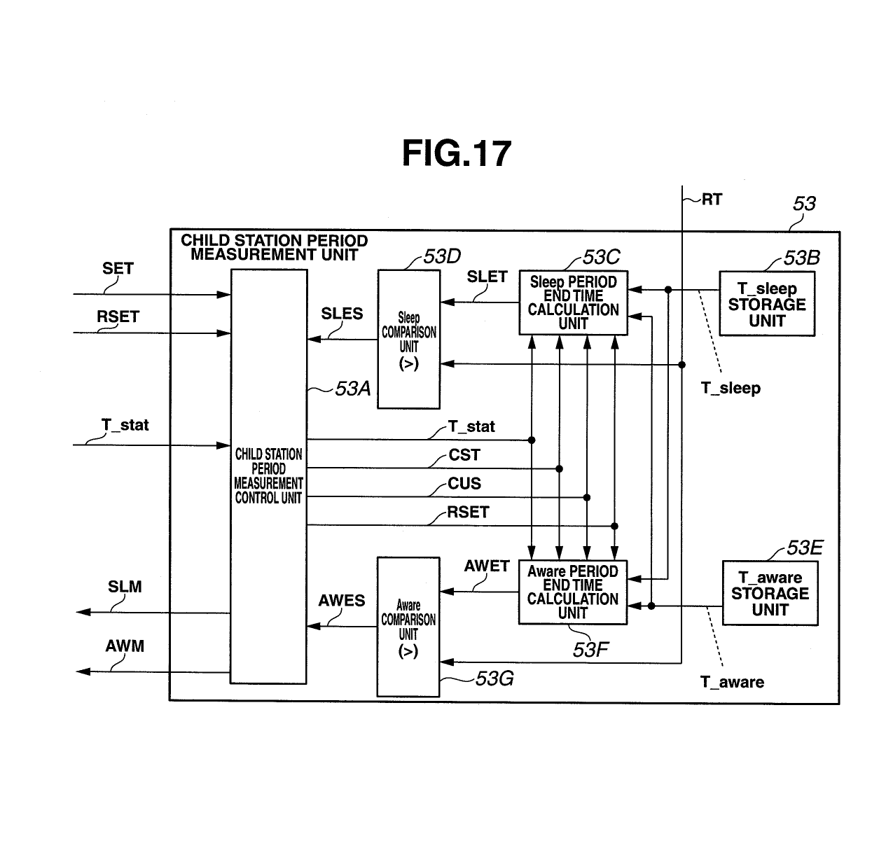

FIG. 17 shows the arrangement of the child station period measurement unit 53 of the ONU 3. The child station period measurement unit 53 of the ONU 3 according to the third embodiment includes a child station period measurement control unit 53A, a T_Sleep storage unit 53B, a Sleep period end time calculation unit 53C, a Sleep comparison unit 53D, a T_Aware storage unit 53E, an Aware period end time calculation unit 53F, and an Aware comparison unit 53G.

The child station period measurement unit 53 presets the value “T_sleep” (time) of the Sleep period in the T_Sleep storage unit 53B, and also presets the value “T_aware” (time) of the Aware period in the T_Aware storage unit 53E. The T_Sleep storage unit 53B and the T_Aware storage unit 53E output the value “T_sleep” of the Sleep period and the value “T_aware” of the Aware period to the Sleep period end time calculation unit 53C and the Aware period end time calculation unit 53F, respectively.

Upon receiving a calculation start signal CST and the start time (T_stat) from the child station period measurement control unit 53A, the Sleep period end time calculation unit 53C and the Aware period end time calculation unit 53F first calculate the Sleep period end time of the first cycle as (T_stat+T_sleep) and the Aware period end time as (T_stat+T_sleep+T_aware), respectively.

Next, upon receiving a calculation update signal CUS from the child station period measurement control unit 53A, the Sleep period end time calculation unit 53C and the Aware period end time calculation unit 53F calculate the Sleep period end time of the second cycle as (T_sleep_end 1+T_aware+T_sleep) and the Aware period end time as (T_aware_end_{—}1+T_sleep+T_aware), respectively.

The Sleep period end time calculation unit 53C and the Aware period end time calculation unit 53F repeat this calculation hereafter. When the reset signal RSET is input from the child station period measurement control unit 53A, and the calculation start signal CST is input next, the calculation starts anew from the first cycle.

The Sleep period end time calculation unit 53C and the Aware period end time calculation unit 53F output the Sleep period end time SLET and the Aware period end time AWET to the Sleep comparison unit 53D and the Aware comparison unit 53G, respectively. The Sleep comparison unit 53D and the Aware comparison unit 53G compare the local time RT of the ONU 3 with the Sleep period end time SLET and the Aware period end time AWET, respectively. If the local time RT has passed the Sleep period end time SLET and the Aware period end time AWET, a Sleep period end signal SLES and an Aware period end signal AWES are output to the child station period measurement control unit 53A.

The child station period measurement unit 53 outputs a Sleep state signal SLM or an Aware state signal AWM to the child station power control unit 32 based on the set signal SET and the reset signal RSET input from the child station power control unit 32 and the Sleep period end signal SLES and the Aware period end signal AWES input from the Sleep comparison unit 53D and the Aware comparison unit 53G, as in the second embodiment.

Upon receiving the set signal SET and the power saving mode start time (T_stat) from the child station power control unit 32, the child station period measurement unit 53 causes the child station period measurement control unit 53A to output the calculation start signal CST and the power saving mode start time (T_stat) to the Sleep period end time calculation unit 53C and the Aware period end time calculation unit 53F.

When each cycle has ended, the child station period measurement unit 53 outputs the calculation update signal CUS to the Sleep period end time calculation unit 53C and the Aware period end time calculation unit 53F. The Sleep period end time calculation unit 53C and the Aware period end time calculation unit 53F add the value “T_sleep” and the value “T_aware” to the Sleep period end time SLET and the Aware period end time AWET of the cycle, thereby calculating the Sleep period end time SLET and the Aware period end time AWET of the next cycle. The child station period measurement unit 53 repeats this operation hereafter. Note that upon receiving the reset signal RSET from the child station power control unit 32, the child station period measurement unit 53 outputs the reset signal RSET to the Sleep period end time calculation unit 53C and the Aware period end time calculation unit 53F and ends the calculation of the Sleep period end time SLET and the Aware period end time AWET.

(3-3) Functions and Effects of Third Embodiment

With the above-described arrangement, when eliminating the time error (Δt) that occurs with respect to the OLT 2 during the Sleep period of the ONU 3, the PON system 1 according to the third embodiment causes the ONU 3 not to recognize the Sleep period end time SLET and the Aware period end time AWET by the control frame CF from the OLT 2 but to calculate the Sleep period end time SLET and the Aware period end time AWET by itself, unlike the second embodiment.

More specifically, in the PON system 1, the ONU 3 ends the Sleep period with a delay of the error (Δt) from the OLT 2 in the first cycle. The reference time of the OLT 2 is synchronized with the local time RT of the ONU 3 in the next Aware period, thereby correcting the Aware period to “T_aware-Δt”. Hence, the error (Δt) can be prevented from accumulating along with the elapse of time. The PON system can thus decrease the number of times of causing the OLT 2 to transmit the control frame of return instruction, as compared to the conventional method that does not correct the error (Δt). It is therefore possible to reduce the load on the OLT 2 and thus prevent an increase in the power consumption without lowering the band utilization efficiency.

At this time, in the ONU 3, the child station period measurement unit 53 can obtain the Sleep period end time SLET and the Aware period end time AWET by calculation in each cycle. This can obviate the necessity of receiving the notification of the Sleep period end time SLET and the Aware period end time AWET from the OLT 2, and therefore further reduce the load on the OLT 2.

According to the above-described arrangement, the PON system 1 can synchronize the reference time of the OLT 2 with the local time RT of the ONU 3 to advance the local time RT by the error (Δt), and eliminate the error (Δt) between the reference clock of the OLT 2 and the local time RT of the ONU 3, as in the second embodiment. Additionally, in the PON system 1, the ONU 3 can obtain the Sleep period end time SLET and the Aware period end time AWET by calculation in each cycle. This makes it possible to reliably return the ONU 3 from the power saving mode to the normal mode while saving the load on the OLT 2 in transmitting the Sleep period end time SLET and the Aware period end time AWET.

(3-4) Other Embodiments Corresponding to Third Embodiment

Note that in the above-described third embodiment, a case has been explained in which the Aware period of the ONU 3 is set to “T_aware-Δt”, thereby correcting the error (Δt). However, the present invention is not limited to this, and “T_sleep-Δt” may be set.

For example, when “T_sleep-Δt” is set, only measurement of the Aware period is done by the child station Aware counter 33E, as in the first embodiment. The control frame CF for time synchronization is thus received from the OLT 2 at the timing of ending the Aware period, and the reference time of the OLT 2 and the local time RT of the ONU 3 are synchronized. As a result, the ONU 3 can advance the local time RT by the error (Δt), and the Sleep period of the ONU 3 becomes shorter than the Sleep period of the OLT 2 by the error (Δt) (“T_sleep-Δt”). For this reason, the reference clock of the OLT 2 can be made to match the local time RT of the ONU 3.

In the above-described third embodiment, a case has been explained in which the child station communication unit 31 of the ONU 3 outputs the local time RT to the child station power control unit 32, and the child station power control unit 32 decides the power saving mode start time (T_stat). However, the present invention is not limited to this, and the child station period measurement unit 53 of the GNU 3 need only know the power saving mode start time (T_stat). For example, the child station communication unit 31 may output the local time RT to the child station period measurement unit 53, and the child station period measurement unit 53 may directly decide the power saving mode start time (T_stat).

In the above-described third embodiment, a case has been explained in which the Sleep period end time SLET of the Sleep period and the Aware period end time AWET of the Aware period are calculated under a condition that the Sleep period and the Aware period are predetermined. However, the present invention is not limited to this, and the Sleep period end time SLET of the Sleep period and the Aware period end time AWET of the Aware period may be calculated under a condition that the Sleep period and the Aware period change for each cycle. In this case as well, the Sleep period end time SLET and the Aware period end time AWET can be calculated. For example, when the Sleep period of the nth cycle is set to “Tsleepn”, and the Aware period is set to “T_aware_n”, the Sleep period end time SLET and the Aware period end time AWET of the nth cycle are obtained as “T_sleep_end_n=T_sleep_end_(n−1)+T_aware+T_sleep” and “T_aware_end_n=T_aware_end_(n−1)+T_sleep+T_Aware”. The calculation method is not limited to this, and various methods are usable.

In the above-described third embodiment, a case has been explained in which the child station period measurement unit 53 calculates the Sleep period end time and the Aware period end time. However, the present invention is not limited to this, and a unit other than the child station period measurement unit 53, for example, the parent station communication unit 21 or the like may perform the calculation.

In the above-described third embodiment, a case has been explained in which one ONU 3 is connected to the OLT 2. However, the present invention is not limited to this, and n (1≦n≦m) ONUs can be controlled by preparing the parent station power control units 22 and the parent station period measurement units 23 of the OLT 2 as many as the ONUs 3 to be connected.

### (4) Fourth Embodiment

In the fourth embodiment as well, a case in which, for example, one OLT and one ONU are provided will be described.

In the above-described first to third embodiments, the time error (Lt) between the OLT 2 and the ONU 3 is small relative to the Sleep period or the Aware period. In the fourth embodiment, however, a time error (Δt) between an OLT 2 and an ONU 3 is too large to neglect relative to the Sleep period or the Aware period. Note that the Sleep period of the nth cycle will be referred to as “T_sleep_n” and the Aware period of the nth cycle will be referred to as “T_aware_n”. The time error that occurs between the OLT 2 and the ONU 3 in the Sleep period “T_sleep_n” of the nth cycle will be referred to as an error (Δt_n).

Assume that the error (Δt) is small. In this case, even when the error (Δt_n) occurs in the Sleep period of the nth cycle, the OLT 2 transmits an Aware frame to the ONU 3 to instruct a return from the power saving mode in the Aware period of the nth cycle so that the ONU 3 can receive the Aware frame from the OLT 2 and return to the normal mode.

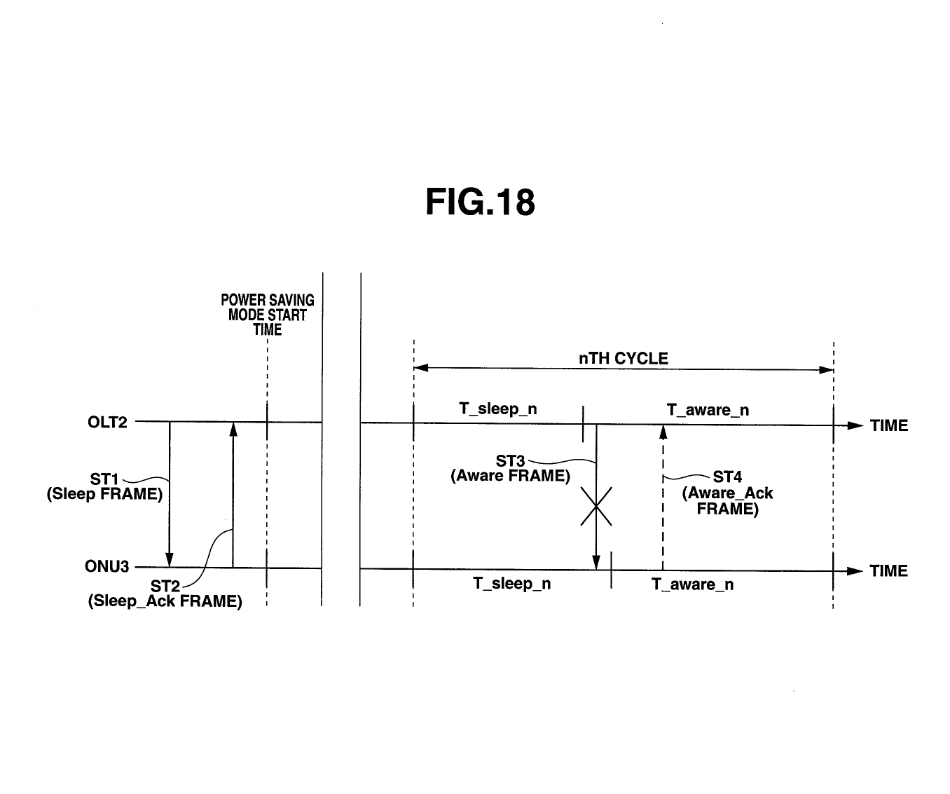

Conversely, assume that the error (Δt) is large. In the communication process of the PON system according to the fourth embodiment, as shown in FIG. 18, if the error (Δt_n) occurs in the Sleep period of the nth cycle, the ONU 3 cannot receive the Aware frame transmitted from the OLT 2 because of the Sleep period and cannot return from the power saving mode to the normal mode.

More specifically, let “T_olt_aware” be the period from the end of the Sleep period of the OLT 2 until its shift to the Aware period and Aware frame transmission to the ONU 3, and “T_olt_onu” be the period until the Aware frame transmitted from the OLT 2 arrives at the ONU 3. In this case, “Δt<T_olt_aware+T_olt_onu” when the error (Δt) is small, and “Δt≧T_olt_aware+T_olt_onu” when the error (Δt) is large.

In the first to third embodiments, the error (Δt_n) that occurs in the Sleep period of the nth cycle is corrected from the Aware period of the nth cycle to the Sleep period of the (n+1)th cycle, thereby preventing the error (Δt_n) from accumulating and attaining a large value. In the fourth embodiment, however, the ONU 3 estimates the error (Δt_n) that occurs in the Sleep period of the nth cycle in advance, corrects its Sleep period by the error (Δt_n) in advance, and then shifts to the Sleep state.

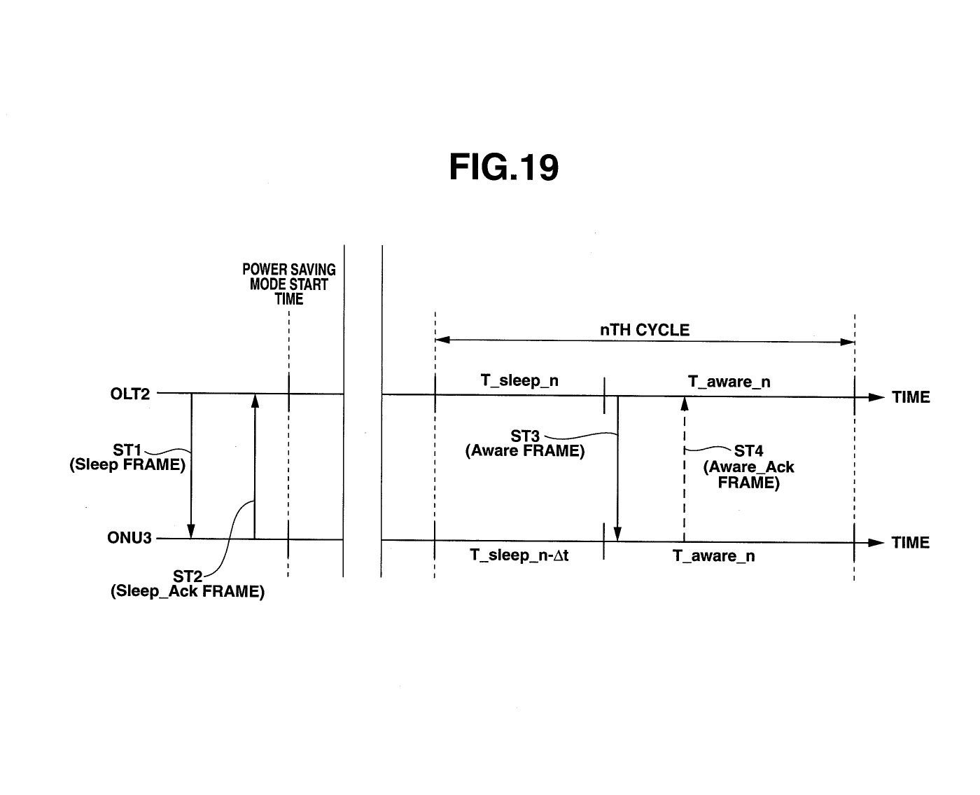

For example, as shown in FIG. 19, in the communication process of the PON system according to the fourth embodiment, even when the OLT 2 instructs the ONU 3 to be in the Sleep period for “T_sleep” by the Sleep frame of step ST1, the ONU 3 estimates the error (Δt) that occurs in the “T_sleep” period in advance, sets the Sleep period of the nth cycle to “T_sleep_n-Δt”, and then shifts to the Sleep state.

A method of estimating the error (Δt) that occurs in the ONU 3 in the fourth embodiment will be described next. Note that in the fourth embodiment, the Sleep period “T_sleep” and the Aware period “T_aware” change for each cycle.

The error (Δt) between the OLT 2 and the ONU 3 is proportional to the length of the Sleep period. In the fourth embodiment, first, an error (Δt_x) that has occurred in a given Sleep period (T_sleep_x) is stored. The error (Δt_n) that occurs in accordance with the length of the Sleep period (T_sleep_n) of the nth cycle is calculated as (Δt_n)=(Δt_x)×(T_sleep_n)/(T_sleep_x). Note that although the error (Δt) is positive in this case as well, the error (Δt) may be negative.

In the fourth embodiment, the ONU 3 estimates, based on an error (Δt_{—}1) obtained in a period of the first cycle, an error that occurs in a subsequent cycle by the same method as in the first embodiment. That is, the error that occurs in the nth cycle is calculated as (Δt_n)=(Δt_{—}1)×(T_sleep_n)/(T_sleep_{—}1).

(4-1) Circuit Arrangements of OLT And ONU of Fourth Embodiment

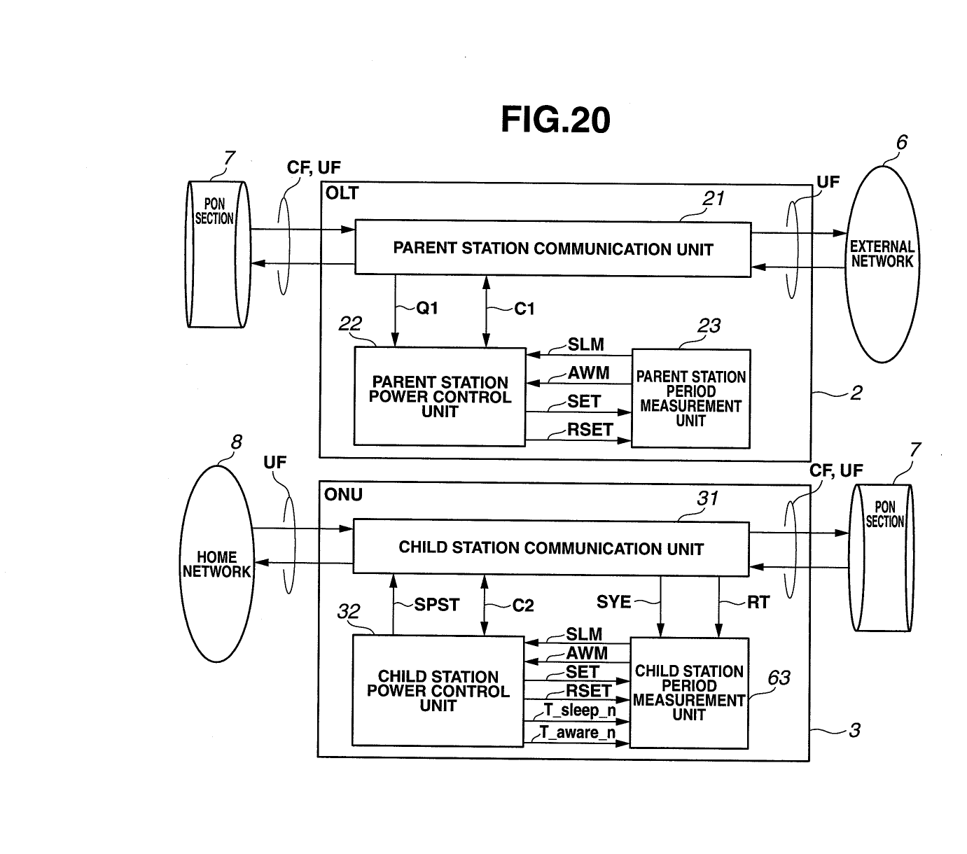

As shown in FIG. 20 in which the same reference numerals as in FIG. 6 denote the corresponding parts, the OLT 2 has the same arrangement as in the first embodiment, and a description thereof will be omitted here. However, the OLT 2 transmits the Sleep period “T_sleep_n” and the Aware period “T_aware_n” of each cycle to the ONU 3 by a control frame CF.

The ONU 3 basically has the same arrangement as in the first embodiment except that a child station power control unit 32 outputs the value “T_sleep_n” of the Sleep period and the value “T_aware_n” of the Aware period of the nth cycle to a child station period measurement unit 63. Note that concerning the arrangement of the ONU 3, a description of the same parts as in the first embodiment will be omitted.

The child station power control unit 32 of the ONU 3 outputs the value “T_sleep_n” of the Sleep period and the value “T_aware_n” of the Aware period, which are transmitted from the OLT 2 by the control frame CF, to the child station period measurement unit 63 at the start of each cycle.

(4-2) Circuit Arrangement of Child Station Period Measurement Unit of ONU

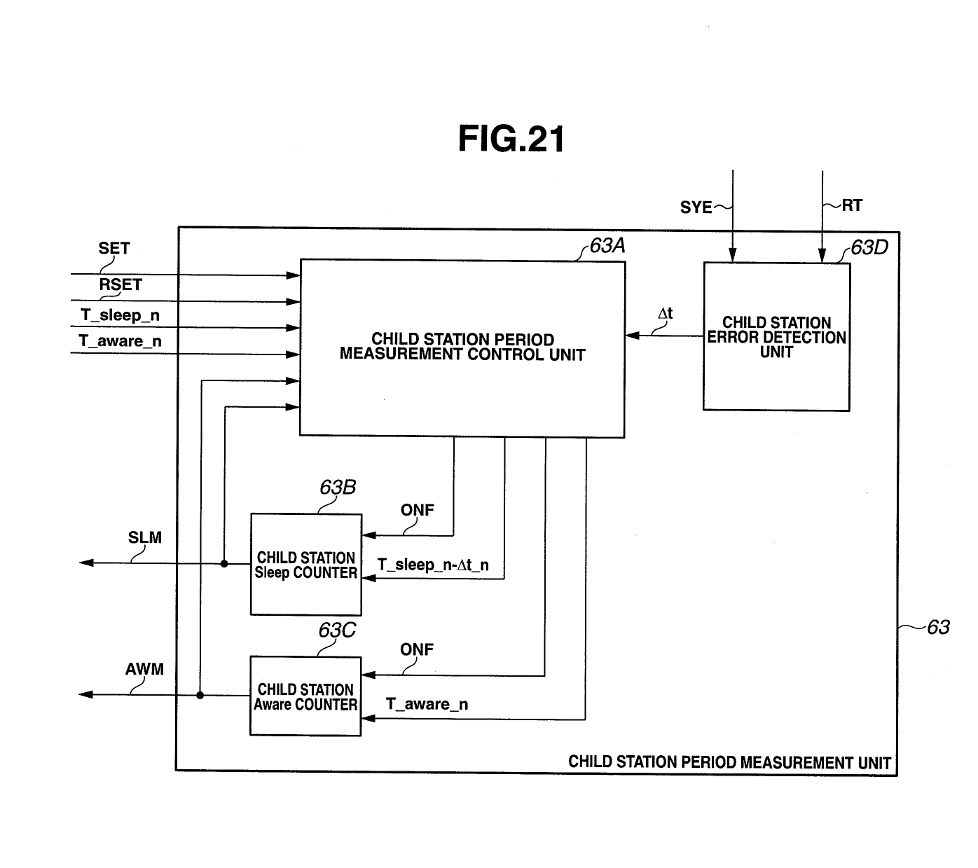

FIG. 21 shows the arrangement of the child station period measurement unit 63 of the ONU 3. The child station period measurement unit 63 of the ONU 3 according to the fourth embodiment includes a child station period measurement control unit 63A, a child station Sleep counter 63B, a child station Aware counter 63C, and a child station error detection unit 63D.

The child station error detection unit 63D of the child station period measurement unit 63 detects the time error (Δt) that occurs between the OLT 2 and the ONU 3 during the Sleep period based on the difference between a local time (synchronized with the reference time of the OLT 2) RT when a synchronization completion signal SYE was input and the immediately preceding local time (not synchronized with the reference time of the OLT 2) RT, as in the first embodiment, and outputs the detected error (Δt) to the child station period measurement control unit 63A.

The child station period measurement control unit 63A outputs an ON/OFF signal ONF to the child station Sleep counter 63B and the child station Aware counter 63C based on a set signal SET and a reset signal RSET input from the child station power control unit 32, thereby controlling the child station Sleep counter 63B and the child station Aware counter 63C, as in the first embodiment. Unlike the first embodiment, the child station period measurement control unit 63A outputs, to the child station Sleep counter 63B, a count (“T_sleep_n-Δt_n”) to be loaded by the child station Sleep counter 63B.

The child station period measurement control unit 63A outputs “T_sleep_n-Δt_n” obtained from the Sleep period “T_sleep_n” of the nth cycle input from the child station power control unit 32 and the error (Δt_n) of the nth cycle estimated by the above-described estimation method to the child station Sleep counter 63B as a count. On the other hand, the child station period measurement control unit 63A directly outputs the value (T_aware_n) of the Aware period input from the child station power control unit 32 to the child station Aware counter 63C as a count. Note that the arrangements and operations of the child station Sleep counter 63B and the child station Aware counter 63C are the same as in the first embodiment, and a description thereof will be omitted for the sake of convenience.

(4-3) Functions and Effects of Fourth Embodiment

With the above-described arrangement, a PON system 1 according to the fourth embodiment causes the ONU 3 to estimate, using the error (Δt) obtained in the period of the first cycle, the error (Δt_n) that occurs in, for example, the subsequent nth cycle.

The ONU 3 sets the Sleep period of the nth cycle to “T_sleep_n-Δt_n” in consideration of the estimated error (Δt_n) and then shifts to the Sleep state. It is therefore possible to reliably obtain a state in which the OLT 2 and the ONU 3 are synchronized in the next Aware period.

As a result, when the OLT 2 transmits the Aware frame to the ONU 3 in the Aware period, the ONU 3 can receive the Aware frame and therefore reliably return from the power saving mode to the normal mode. The PON system 1 can thus decrease the number of times of causing the OLT 2 to transmit the control frame of return instruction, as compared to the conventional method that does not correct the error (Δt). It is therefore possible to reduce the load on the OLT 2 and thus prevent an increase in the power consumption without lowering the band utilization efficiency.

According to the above-described arrangement, in the PON system 1, even if the time error (Δt) between the OLT 2 and the ONU 3 is too large to neglect relative to the Sleep period or the Aware period, the ONU 3 estimates the error (Δt_n) of the nth cycle in advance, sets the Sleep period of the nth cycle to “T_sleep_n-Δt_n” in consideration of the estimated error (Δt_n), and then shifts to the Sleep state. Hence, in the PON system, the OLT 2 and the ONU 3 are synchronized in the next Aware period, and the ONU 3 can reliably receive the Aware frame from the OLT 2 and reliably return from the power saving mode to the normal mode.

(4-4) Other Embodiments Corresponding to Fourth Embodiment

Note that in the above-described fourth embodiment, a case has been explained in which based on the error (Δt) that has occurred in the Sleep period of the first cycle, the error (Δt_n) that occurs in the subsequent nth cycle is estimated. However, the present invention is not limited to this, and the ONU 3 may set a mode to confirm the clock deviation between the OLT 2 and the ONU 3 before the shift to the power saving mode.

In the above-described fourth embodiment, a case has been explained in which based on the error (Δt) that has occurred in the Sleep period of the first cycle, the error (Δt_n) that occurs in the subsequent nth cycle is estimated. However, the present invention is not limited to this, and the error that occurs in a subsequent cycle may be estimated using the error (Δt) that has occurred in an arbitrary cycle. For example, a period for error estimation may be provided at a predetermined time interval. The estimation may be done based on the error that has occurred in the previous power saving mode. An error at the standard temperature may be preset, and an error that occurs in a subsequent cycle may be estimated using it. An error for each temperature may be preset, and the apparatus may measure the temperature to estimate the error that occurs in a subsequent cycle.

In the above-described fourth embodiment, a case has been explained in which the error (Δt_n) that occurs in the nth cycle is estimated and corrected. However, the present invention is not limited to this. Since the estimated error (Δt_n) does not necessarily exactly match the error that actually occurs, the same processing as in the first to third embodiments may be performed together to further modify the Aware period.

In the above-described fourth embodiment, a case has been explained in which one ONU 3 is connected to the OLT 2. However, the present invention is not limited to this, and n (1≦n≦m) ONUs can be controlled by preparing the parent station power control units 22 and the parent station period measurement units 23 of the OLT 2 as many as the ONUs 3 to be connected.

### (5) Fifth Embodiment

In the fifth embodiment as well, a case in which, for example, one OLT and one ONU are provided will be described.

In the above-described fourth embodiment, the ONU 3 estimates the error (Δt_n) that occurs in the nth cycle, and the “T_sleep” period of the ONU 3 is corrected to “T_sleep_n-Δt_n”. This allows the ONU 3 to receive the control frame of return instruction from the power saving mode to the normal mode from the OLT 2 even if the error (Δt_n) is too large to neglect relative to the Sleep period or the Aware period.

However, the fifth embodiment is different from the fourth embodiment in that an OLT 2 estimates an error (Δt_n) and transmits a control frame CF of return instruction from the power saving mode to the normal mode at a time at which an ONU 3 can receive the control frame.

The procedure until the OLT 2 transmits the control frame CF of return instruction from the power saving mode to the normal mode to the ONU 3 in the fifth embodiment will be described. In this case, the ONU 3 detects an error (Δt) and transmits it to the OLT 2. The OLT 2 estimates the error (Δt_n) that occurs in the nth cycle using the error (Δt) by the same method as in the fourth embodiment. Finally, when the OLT 2 transmits the control frame CF of return instruction from the power saving mode to the normal mode to the ONU 3, control is performed to transmit the control frame CF after the elapse of time equal to or more than the error (Δt_n) from the end of the Sleep period of the OLT 2. Note that the transmission may be done at a timing earlier by a time necessary for the control frame CF transmitted from the OLT 2 to arrive at the ONU 3, as a matter of course.

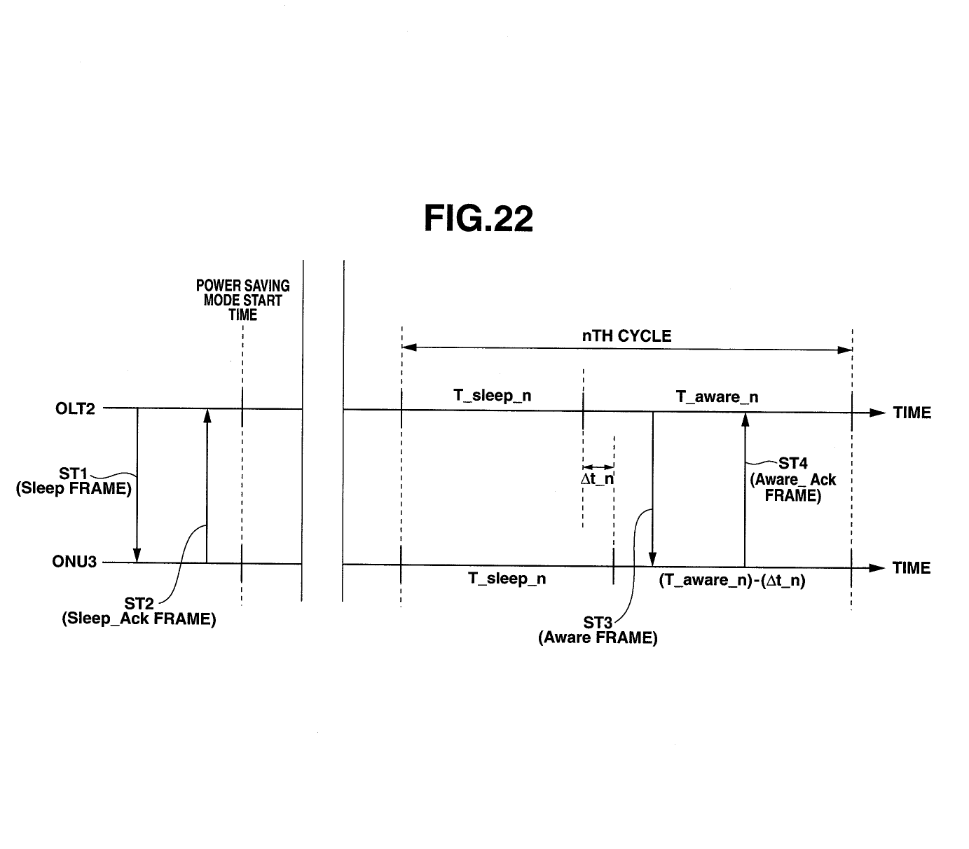

In the communication process of a PON system 1 according to the fifth embodiment, as shown in FIG. 22, the ONU 3 corrects the Aware period of the nth cycle to “T_aware_n-Δt_n” based on the error (Δt_n) that occurs in the nth cycle by the same method as in the first embodiment (FIG. 5), thereby preventing the error from accumulating. Additionally, in this communication process, to prevent the ONU 3 from being unable to receive the control frame CF of return instruction from the OLT 2 due to the error (Δt_n) that occurs in the nth cycle, the OLT 2 estimates the error (Δt_n) and transmits the control frame (Aware frame) CF of return instruction at the timing of step ST3 after the elapse of time equal to or more than the error (Δt_n) from the end of the Sleep period. Note that although the error (Δt) is positive in this case as well, the error (Δt) may be negative.

(5-1) Circuit Arrangements of OLT And ONU of Fifth Embodiment

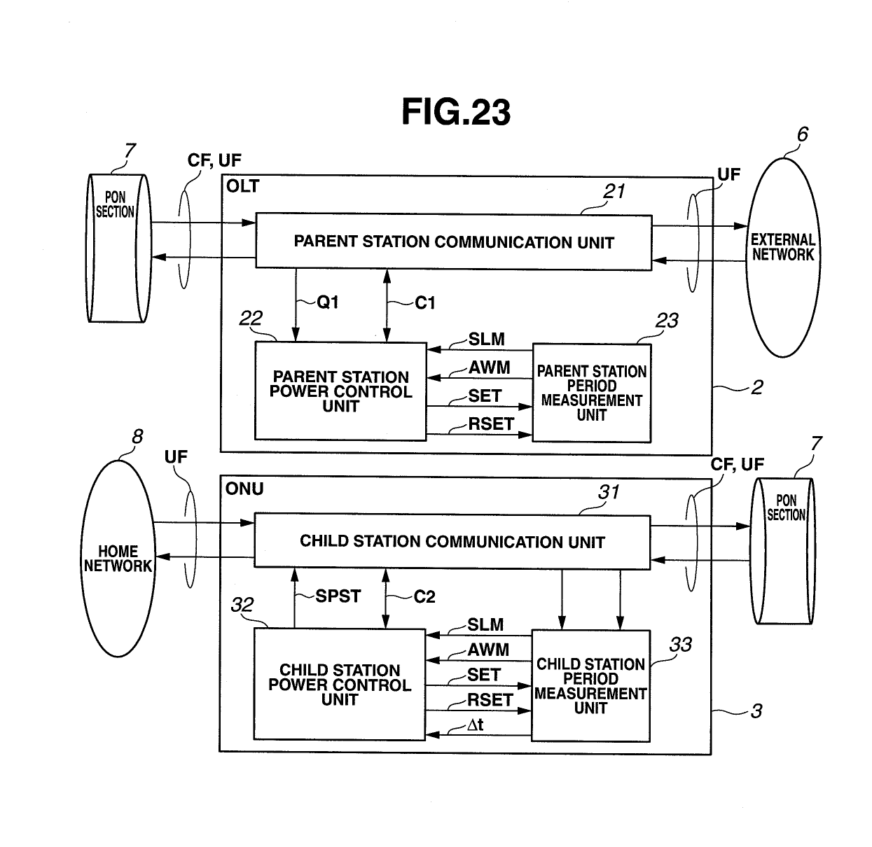

As shown in FIG. 23 in which the same reference numerals as in FIG. 6 denote the corresponding parts, the OLT 2 has the same arrangement as in the first embodiment, and a description thereof will be omitted here. However, unlike the first embodiment, a parent station communication unit 21 of the OLT 2 stores the error (Δt) transmitted from the ONU 3, and estimates the error (Δt_n) that occurs in the nth cycle. When transmitting the control frame CF of return instruction via the parent station communication unit 21, the OLT 2 operates after the elapse of time equal to or more than the error (Δt_n) from the end of the Sleep period.

The ONU 3 is almost the same as in the first embodiment except that a child station period measurement unit 33 outputs the detected error (Δt) to a child station power control unit 32 by a control signal C2. The child station power control unit 32 transmits the error (Δt) to the OLT 2 via the parent station communication unit 21 by the control frame CF. Note that concerning the arrangement of the ONU 3, a description of the same parts as in the first embodiment will be omitted.

(5-2) Functions and Effects of Fifth Embodiment

With the above-described arrangement, in the PON system 1 according to the fifth embodiment, the OLT 2 receives the error (Δt) detected by the ONU 3 and estimates the error (Δt_n) that occurs in the nth cycle. After that, when transmitting the control frame CF of return instruction from the power saving mode to the normal mode to the ONU 3, the OLT 2 transmits the control frame CF after the elapse of time equal to or more than the error (Δt_n) in the nth cycle from the end of the Sleep period of the OLT 2. Hence, in the PON system 1, the control frame can reliably be transferred from the OLT 2 to the ONU 3 in a time zone where the ONU 3 is predicted to be in the Aware period.

At this time, the ONU 3 corrects the Aware period of the nth cycle to “T_aware_n-Δt_n” based on the error (Δt_n) that occurs in the nth cycle by the same method as in the first embodiment (FIG. 5), thereby preventing the error from accumulating. Hence, in the PON system 1 according to the fifth embodiment, both the OLT 2 and the ONU 3 give consideration so that the ONU 3 can reliably receive the control frame CF of return instruction transmitted from the OLT 2.

Even if the error (Δt) between the OLT 2 and the ONU 3 is too large to neglect relative to the Sleep period or the Aware period, the ONU 3 can reliably receive the control frame CF transmitted from the OLT 2.

Hence, the ONU 3 can reliably return from the power saving mode to the normal mode in the Aware period. The PON system 1 can thus decrease the number of times of causing the OLT 2 to transmit the control frame CF of return instruction, as compared to the conventional method that does not correct the error (Δt). It is therefore possible to reduce the load on the OLT 2 and thus prevent an increase in the power consumption without lowering the band utilization efficiency.

According to the above-described arrangement, in the PON system 1, even if the time error (Δt) between the OLT 2 and the ONU 3 is too large to neglect relative to the Sleep period or the Aware period, the OLT 2 estimates the error (Δt_n) that occurs in the nth cycle based on the error (Δt) detected by the ONU 3, and transmits the control frame CF of return instruction to the ONU 3 after the elapse of time equal to or more than the error (Δt_n) from the end of the Sleep period of the OLT 2. Hence, the ONU 3 can reliably receive the Aware frame from the OLT 2 and reliably return from the power saving mode to the normal mode.

(5-3) Other Embodiments Corresponding to Fifth Embodiment

Note that in the above-described fifth embodiment, a case has been explained in which based on the error (Δt) that has occurred in the Sleep period of the first cycle in the ONU 3, the OLT 2 estimates the error (Δt_n) that occurs in the subsequent nth cycle. However, the present invention is not limited to this, and the OLT 2 may estimate the error (Δt_n) that occurs in a subsequent cycle based on the error (Δt) of an arbitrary cycle estimated by the ONU 3. The OLT 2 may perform estimation based on the error that has occurred in the previous power saving mode. The OLT 2 may preset an error at the standard temperature and estimates an error that occurs in a subsequent cycle using it. The OLT 2 may preset an error for each temperature, and the apparatus may measure the temperature to estimate the error that occurs in a subsequent cycle.

In the above-described fifth embodiment, a case has been explained in which the OLT 2 estimates the error (Δt_n) that occurs in the nth cycle based on the error (Δt) detected by the ONU 3, and corrects the error (Δt_n). However, the present invention is not limited to this. Since the estimated error (Δt_n) does not necessarily exactly match the error that actually occurs, the same processing as in not only the first embodiment but also the second and third embodiments may be performed together to further modify the Aware period.

In the above-described fifth embodiment, a case has been explained in which one ONU 3 is connected to the OLT 2. However, the present invention is not limited to this, and n (1≦n≦m) ONUs can be controlled by preparing the parent station power control units 22 and the parent station period measurement units 23 of the OLT 2 as many as the ONUs 3 to be connected.

### (6) Sixth Embodiment

The sixth embodiment is particularly a modification of the first embodiment, and a case in which, for example, one OLT and one ONU are provided will be described.

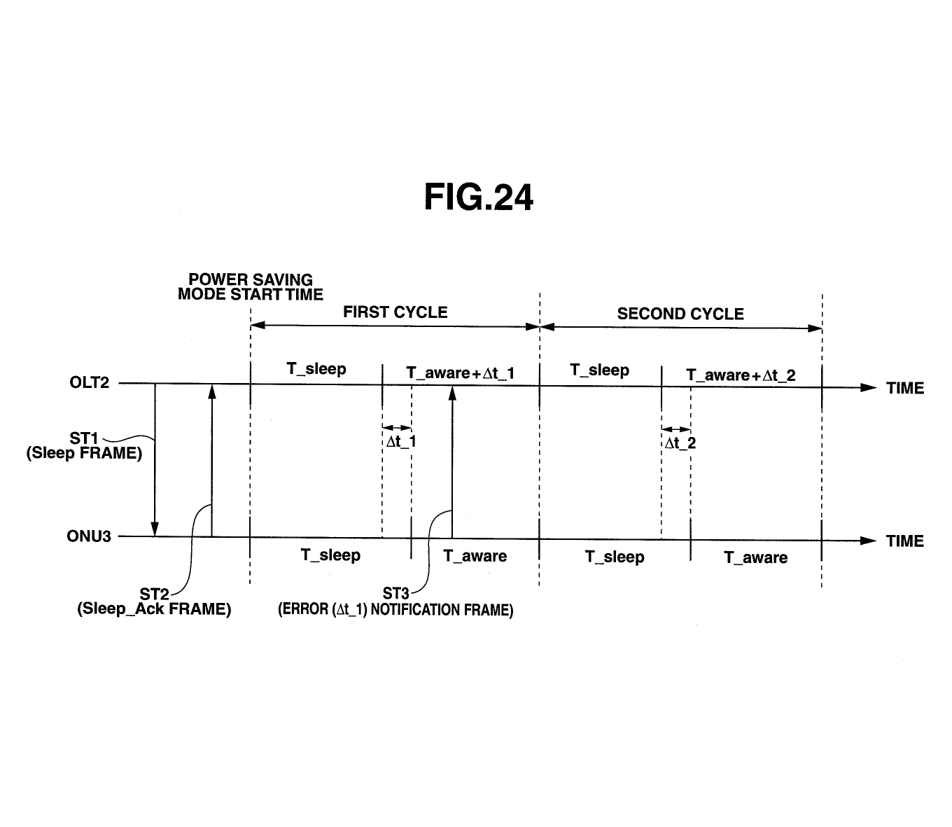

As shown in FIG. 24 in which the same reference numerals as in FIG. 5 denote the corresponding parts, in the communication process of a PON system 1 according to the sixth embodiment, a time error (Δt_{—}1) that occurs between a local time RT of an ONU 3 and the reference time of an OLT 2 in the Sleep period of the ONU 3 is detected during the Aware period of the ONU 3 in the first cycle in which transmission/reception of a control frame CF is enabled between the OLT 2 and the ONU 3, and time synchronization with the OLT 2 can be established.

In the communication process according to the sixth embodiment, the control frame (error (Δt_{—}1) notification frame) CF with which the ONU 3 notifies the OLT 2 of the error (Δt_{—}1) is transmitted to the OLT 2 at time of step ST3 during the Aware period of the ONU 3 in the first cycle after time synchronization with the OLT 2.

The OLT 2 corrects the Aware period of the first cycle to “T_aware+Δt 1”, thereby correcting the error (Δt_{—}1) until the end of the first cycle. Next, the OLT 2 estimates an error (Δt_{—}2) in the second cycle by the same method as in the fourth embodiment, and corrects the Aware period of the second cycle to “T_aware+Δt^{—}2”, thereby correcting the error (Δt_{—}2) until the end of the second cycle. Subsequently, the OLT 2 estimates the error (Δt_n) from the nth cycle and corrects it during the Aware period of the nth cycle. For this reason, the ONU 3 need not detect the error (Δt_{—}1) and notify the OLT 2 of it from the second cycle.

Note that although FIG. 24 shows a case in which the error (Δt_{—}1) is positive, the error (Δt_{—}1) may be negative. The error (Δt_{—}1) is sufficiently small relative to the Sleep period or the Aware period. The first embodiment solves the problem of the error (Δt_{—}1) that accumulates and attains a large value along with the elapse of time.

In the sixth embodiment, a case in which one OLT 2 and one ONU 3 are provided has been described. When a plurality of ONUs 3 are connected to the OLT 2, the error (Δt_{—}1) changes between the plurality of ONUs 3, and a plurality of parent station period measurement units 23 and a plurality of child station period measurement units 33 are necessary.

(6-1) Circuit Arrangements of OLT And ONU of Sixth Embodiment

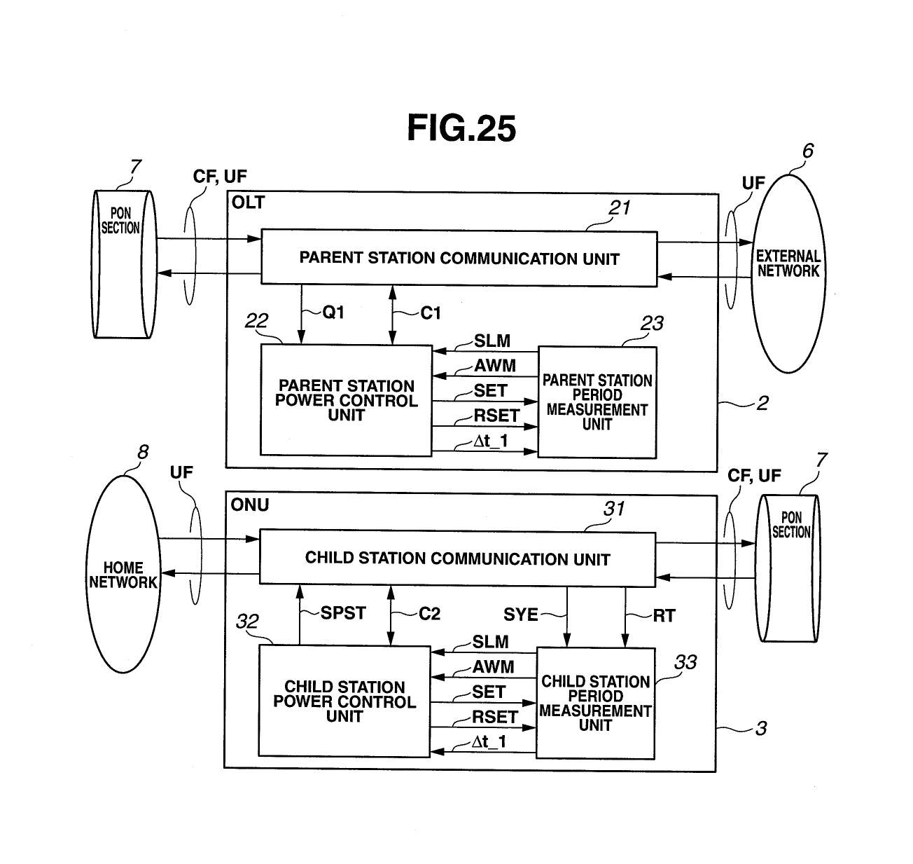

As shown in FIG. 25 in which the same reference numerals as in FIG. 6 denote the corresponding parts, in the ONU 3, a child station period measurement unit 33 detects, in the Aware period of the first cycle of the ONU 3 in which time synchronization with the OLT 2 is established, the error (Δt_{—}1) that occurs between the local time RT of the ONU 3 and the reference time of the OLT 2 in the Sleep period of the ONU 3, and the error (Δt_{—}1) is transmitted to the OLT 2.

A parent station power control unit 22 of the OLT 2 outputs the error (Δt_{—}1) received from the ONU 3 to a parent station period measurement unit 23. The parent station period measurement unit 23 corrects the Aware period of the first cycle from preset “T_aware” to “T_aware+Δt_{—}1” using the error (Δt_{—}1). The end timing of the Aware period “T_aware+Δt_{—}1” of the OLT 2 and the end timing of the Aware period “T_aware” of the ONU 3 are thus synchronized.

From the second cycle, the parent station power control unit 22 of the OLT 2 estimates errors (Δt_{—}2), (Δt_{—}3), . . . , (Δt_n) using the same method as in the fourth embodiment based on the error (Δt_{—}1), and corrects the Aware period from the second cycle to “T_aware+Δt_{—}1”, “T_aware+Δt_{—}2”, . . . , “T_aware+Δt_n” using the errors.

(6-2) Functions and Effects of Sixth Embodiment

With the above-described arrangement, in the PON system 1 according to the sixth embodiment, the time error (Δt_{—}1) with respect to the OLT 2 that occurs in the nth Sleep period of the ONU 3 is detected in the Sleep period of the first cycle of the ONU 3 in which transmission/reception of the control frame CF is enabled between the OLT 2 and the ONU 3, and the error (Δt_{—}1) is transmitted from the ONU 3 to the OLT 2 during the Sleep period of the first cycle.

The OLT 2 of the PON system 1 sets the Aware period to “T_aware+Δt_{—}1” during the Aware period of the first cycle using the error (Δt_{—}1) received from the ONU 3, thereby correcting the error (Δt_{—}1) between the reference clock of the OLT 2 and the local time RT of the ONU 3.

In the above-described way, the OLT 2 corrects the error (Δt_{—}1) during the Aware period of the first cycle. Hence, the error (Δt_{—}1) between the OLT 2 and the ONU 3 never accumulates along with the elapse of time, and the synchronized state can always be maintained. The PON system 1 can thus decrease the number of times of causing the OLT 2 to transmit the control frame of return instruction, as compared to the conventional method that does not correct the error (Δt_{—}1). It is therefore possible to reduce the load on the OLT 2 and thus prevent an increase in the power consumption without lowering the band utilization efficiency.

According to the above-described arrangement, the PON system 1 detects, in the Aware period of the first cycle of the ONU 3, the time error (Δt_{—}1) that occurs with respect to the OLT 2 during the Sleep period of the ONU 3. The OLT 2 corrects the error (Δt_{—}1) during the Aware period of the first cycle and set the Aware period to “T_aware+Δt_{—}1”. In the PON system 1, the error (Δt_{—}1) between the reference clock of the OLT 2 and the local time RT of the ONU 3 can thus be corrected, and time synchronization can be established during the first cycle. This makes it possible to reliably return the ONU 3 from the power saving mode to the normal mode without increasing the load on the OLT 2.

(6-3) Other Embodiments Corresponding to Sixth Embodiment

Note that in the above-described sixth embodiment, a case has been explained in which the ONU 3 detects the error (Δt_{—}1) and transmits it to the OLT 2 during the Aware period of the power saving mode.

However, the present invention is not limited to this.

An error detection mode to detect the error (Δt_{—}1) may be set before the power saving start time, and the error (Δt_{—}1) may be transmitted from the ONU 3 to the OLT 2 before the power saving start time.

In the above-described sixth embodiment, a case has been explained in which the OLT 2 corrects the error (Δt_{—}1) during the Aware period of the first cycle. However, the present invention is not limited to this, and the error (Δt_{—}1) may be corrected during the Sleep period of the second cycle, and the Sleep period of the second cycle may be set to “T_sleep+Δt_{—}1”. Alternatively, the Aware period of the first cycle may be set to “T_aware+(Δt_{—}1)/2”, and the Sleep period of the second cycle may be set to “T_sleep+(Δt_{—}1)/2”.

In the above-described sixth embodiment, a case has been explained in which the ONU 3 detects the error (Δt_{—}1) during the Aware period of the power saving mode. However, the present invention is not limited to this, and the OLT 2 may detect the time error (Δt_{—}1) that occurs in the Sleep period of the ONU 3 between the local time RT of the ONU 3 and the reference time of the OLT 2 by receiving the local time RT from the ONU 3 during the Aware period of the first cycle in which the time synchronization with respect to the ONU 3 can be established.

### INDUSTRIAL APPLICABILITY

The present invention is usable in the communication field and, more particularly, in various systems in which the parent station has a reference time, and the parent station and a child station that has established time synchronization with the parent station communicate with each other.

### EXPLANATION OF THE REFERENCE NUMERALS AND SIGNS

1 . . . PON system, 2 . . . OLT, 3 . . . ONU, 21 . . . parent station communication unit, 22 . . . parent station power control unit, 23 . . . parent station period measurement unit, 31 . . . child station communication unit, 32 . . . child station power control unit, 33, 43, 53, 63 . . . child station period measurement unit

1. A communication system including a parent station and one or a plurality of child stations,
said parent station comprising:
a parent station communication unit that has a reference time and communicates with said plurality of child stations;
one or a plurality of parent station power control units each of which determines whether said child station should be in a power saving mode in which an apparatus is periodically partially or wholly stopped or in a normal mode in which the apparatus is operated without being partially or wholly stopped, and instructs said child station to change a mode; and
one or a plurality of parent station period measurement units each of which measures a stop period in which the apparatus of the child station is partially or wholly stopped and a non-stop period in which the apparatus of the child station is not stopped in the power saving mode, and
said child station comprising:
a child station communication unit that performs communication while synchronizing the reference time of said parent station with a local time of said child station;
a child station power control unit that changes the mode between the power saving mode and the normal mode of the child station in accordance with the mode change instruction from said parent station; and
a child station period measurement unit that measures the stop period and the non-stop period of said child station,
wherein said child station period measurement unit performs correction for one or both of the stop period and the non-stop period in the power saving mode using an error obtained by calculating a difference that is generated during the power saving mode between the reference time of said parent station and the local time of the child station.

2. A communication system according to claim 1, wherein said child station period measurement unit is configured to subtract a value of the error obtained by calculating the difference between the local time at the time of completion of the time synchronization with the parent station and the local time immediately before the completion of the time synchronization from a value of one or both of the stop period and the non-stop period of the child station in the power saving mode, thereby performing the correction.

3. A communication system according to claim 1, wherein said child station period measurement unit is configured to calculate, as an estimated error, an error that occurs in accordance with a length of the subsequent stop period based on a value of the error that has occurred in the stop period of said child station, and subtract a value of the estimated error from the value of one or both of the subsequent stop period and the subsequent non-stop period, thereby performing the correction.

4. A communication system according to claim 1, wherein said child station causes said child station communication unit to notify said parent station of a value of the error that occurs in the stop period of said child station, and
said parent station causes, based on a value of the error notified by said child station, said parent station power control unit to calculate an error that occurs in accordance with a length of the stop period of said child station as an estimated error, and in the subsequent stop period of said child station, instructs said child station to return from the power saving mode to the normal mode after an elapse of time not less than the value of the error from completion of the stop period.

5. A communication system according to claim 1, wherein the stop period or the non-stop period of said child station in the power saving mode comprises one of a period preset for said child station, a period until the local time of said child station passes an end time of the stop period or the non-stop period notified from said parent station to said child station, and a period until the local time of said child station passes the end time of the stop period or the non-stop period calculated by said child station from a start time of the power saving mode.

6. A communication method including a parent station and one or a plurality of child stations that communicate with the parent station, comprising:
a reference time notification step of causing a parent station communication unit of the parent station, which has a reference time, to communicate with the plurality of child stations, thereby transmitting the reference time of the parent station to the child stations;
a time synchronization step of causing a child station communication unit of each of the child stations to receive the reference time of the parent station and synchronize the reference time of the parent station with a local time of the child station;
a mode change instruction step of causing one or a plurality of parent station power control units of the parent station to determine whether the child station should be in a power saving mode in which an apparatus is periodically partially or wholly stopped or in a normal mode in which the apparatus is operate without being partially or wholly stopped, and instruct the child station to change a mode;
a mode change processing step of causing a child station power control unit of the child station to change the mode between the power saving mode and the normal mode of the child station in accordance with the mode change instruction from the parent station;
a parent station period measurement step of causing one or a plurality of parent station period measurement units of the parent station to measure a stop period in which the apparatus of the child station is partially or wholly stopped in the power saving mode and a non-stop period in which the apparatus of the child station is not stopped; and
a child station period measurement step of causing a child station period measurement unit of the child station to measure the stop period and the non-stop period of the child station,
wherein in child station period measurement step, correction for one or both of the stop period and the non-stop period in the power saving mode is performed using an error obtained by calculating a difference that is generated during the power saving mode between the reference time of the parent station and the local time of the child station.

7. A communication system including a parent station and one or a plurality of child stations,
said parent station comprising:
a parent station communication unit that has a reference time and communicates with said plurality of child stations;
one or a plurality of parent station power control units each of which determines whether said child station should be in a power saving mode in which an apparatus is periodically partially or wholly stopped or in a normal mode in which the apparatus is operated without being partially or wholly stopped, and instructs said child station to change a mode; and
one or a plurality of parent station period measurement units each of which measures a stop period in which the apparatus of the child station is partially or wholly stopped and a non-stop period in which the apparatus of the child station is not stopped in the power saving mode, and
said child station comprising:
a child station communication unit that performs communication while synchronizing the reference time of said parent station with a local time of said child station;
a child station power control unit that changes the mode between the power saving mode and the normal mode of the child station in accordance with the mode change instruction from said parent station; and
a child station period measurement unit that measures the stop period and the non-stop period of said child station,
wherein said child station period measurement unit obtains an error by calculating a difference that is generated during the power saving mode between the reference time of said parent station and the local time of the child station, and said child station communication unit transmits the error to said parent station, and
said parent station period measurement unit performs the correction for one or both of the stop period and the non-stop period in the power saving mode using the error received from said child station by said parent station communication unit.

8. A communication method including a parent station and one or a plurality of child stations that communicate with the parent station, comprising:
a reference time notification step of causing a parent station communication unit of the parent station, which has a reference time, to communicate with the plurality of child stations, thereby transmitting the reference time of the parent station to the child stations;
a time synchronization step of causing a child station communication unit of each of the child stations to receive the reference time of the parent station and synchronize the reference time of the parent station with a local time of the child station;
a mode change instruction step of causing one or a plurality of parent station power control units of the parent station to determine whether the child station should be in a power saving mode in which an apparatus is periodically partially or wholly stopped or in a normal mode in which the apparatus is operate without being partially or wholly stopped, and instruct the child station to change a mode;
a mode change processing step of causing a child station power control unit of the child station to change the mode between the power saving mode and the normal mode of the child station in accordance with the mode change instruction from the parent station;
a parent station period measurement step of causing one or a plurality of parent station period measurement units of the parent station to measure a stop period in which the apparatus of the child station is partially or wholly stopped in the power saving mode and a non-stop period in which the apparatus of the child station is not stopped; and
a child station period measurement step of causing a child station period measurement unit of the child station to measure the stop period and the non-stop period of the child station,
wherein in child station period measurement step, an error is obtained by calculating a difference that is generated during the power saving mode between the reference time of the parent station and the local time of the child station, and the child station communication unit transmits the error to the parent station, and
in the parent station period measurement step, the correction for one or both of the stop period and the non-stop period is performed in the power saving mode using the error received from the child station by the parent station communication unit.

9. A child station of a communication system, comprising:
a child station communication unit that performs communication while synchronizing a reference time of a parent station of the communication system with a local time of the child station itself;
a child station power control unit that changes a mode between a power saving mode in which an apparatus is periodically partially or wholly stopped and a normal mode in which the apparatus is operated without being partially or wholly stopped in accordance with a mode change instruction from the parent station; and
a child station period measurement unit that measures the stop period in which the apparatus of the child station is partially or wholly stopped and the non-stop period in which the apparatus of the child station is not stopped in the power saving mode,
wherein said child station period measurement unit performs correction for one or both of the stop period and the non-stop period in the power saving mode using an error obtained by calculating a difference that is generated during the power saving mode between the reference time of the parent station and the local time of the child station.

10. A communication method comprising:
a communication step of causing a child station communication unit of a child station to perform communication while synchronizing a reference time of a parent station including in a communication system with a local time of the child station including in the communication system and connected to the parent station;
a mode change step of causing a child station power control unit of the child station to change a mode of the child station between a power saving mode and a normal mode of the child station in accordance with a mode change instruction from the parent station; and
a measurement step of causing a child station period measurement unit of the child station to measure a stop period in which an apparatus of the child station is partially or wholly stopped and the non-stop period in which the apparatus of the child station is not stopped in the power saving mode,
wherein in the measurement step, correction for one or both of the stop period and the non-stop period is performed in the power saving mode using an error obtained by calculating a difference that is generated during the power saving mode between the reference time of the parent station and the local time of the child station.
